(19) United States
(12) Patent Application Publication
(10) Pub. No.: US 2014/0271932 A1
(43) Pub. Date: Sep. 18, 2014

(54) RODENTICIDAL COMPOSITION AND METHOD

(71) Applicant: PIC Corporation/Pest Free Living, Linden, NJ (US)

(72) Inventors: Phyllis Rubel, Scotch Plains, NJ (US); Sidney Goldman, Verona, NJ (US); Bogdan Enache, Jersey City, NJ (US)

(21) Appl. No.: 13/829,332

(22) Filed: Mar. 14, 2013

(51) Int. Cl. A01N 59/00

(52) U.S. Cl. CPC A01N 59/00
USPC 424/717

(57) ABSTRACT

A rodenticidal composition comprising a carbon dioxide release agent and a carrier may be disclosed. A method of controlling rodents at a locus by applying the composition of the disclosure may be disclosed.

The present disclosure relates to a rodenticide or composition and method for controlling rodents, e.g. commensal rodents.

The present disclosure may include a composition comprising a rodenticidally effective amount of a carbon dioxide release agent and a rodenticidally acceptable carrier. By the term “carbon dioxide release agent” may be meant generally a material that upon reaction with heat or an acid e.g., a Lewis acid, or a proton donor releases carbon dioxide. In another embodiment of the present disclosure the composition may consist essentially of the carbon dioxide release agent and the carrier. The composition may consist essentially of other ingredients, e.g. another active ingredient, or another carrier.

By the term rodenticidally effective amount may be generally meant an amount of the carbon dioxide release agent sufficient to induce or cause death of a rodent upon ingestion of the carbon dioxide release agent by the rodent. By the term rodenticidally acceptable carrier may be generally meant a composition acceptable for commercial use in conjunction with the carbon dioxide release agent when ingested by the rodent. In another embodiment of the present disclosure, the composition may be substantially repellent and/or distasteful to domestic animals, particularly dogs and/or cats.

In another embodiment of the present disclosure, by the term repellent and/or distasteful may be meant a composition which may be dosed and or chosen to be selectively repellent and/or distasteful to domestic animals and comestibly acceptable to rodents. For example, a selective bittering agent, e.g., a denatonium cation (for example, denatonium benzoate) or a saccharide thereof, for example denatonium saccharide, may be dosed in the composition of the disclosure to provide a rodenticidally acceptable carrier. In another aspect of the present disclosure the composition may further comprise a natural bittering agent such as: Jamaican Quassia extract, artemisia absinthium, naringin (grapefruit peel) orange and/or lemon peel, at a rodent-comestibly acceptable dose; and a dose comestibly unacceptable to humans and/or non-target animals.

In another embodiment of the present disclosure, the carbon dioxide release agent may be a carbonate salt a bicarbonate salt or a mixture thereof. Typically, the carbonate salt and/or the bicarbonate salt may comprise a metal cation. In general, the metal cation may be selected from the group consisting of alkali metal (Group 1) cations and alkaline earth metal (Group 2) cations. The metal cation may comprise a transition metal cation. In the present specification and claims, the above recited metal descriptions are found in the periodic table of FIG. 1. In another embodiment of the present disclosure the metal may be selected from the group consisting of lithium, sodium, potassium, cesium, rubidium, beryllium, magnesium, calcium, strontium and mixtures thereof.

In another embodiment of the present disclosure, the carbon dioxide release agent may include one or more of the following compounds: lithium carbonate, lithium bicarbonate, sodium carbonate, sodium bicarbonate, potassium carbonate, potassium bicarbonate, cesium carbonate, cesium bicarbonate, rubidium carbonate, rubidium bicarbonate, beryllium carbonate, beryllium bicarbonate, magnesium carbonate, calcium carbonate, strontium carbonate, barium carbonate, and mixtures thereof.

In another embodiment of the present disclosure the carbonate salt and/or the bicarbonate salt may further comprise an ammonium cation. The nitrogen of the ammonium cation may be substituted with from 1 to 4 substituents each of which may be alkyl, phenyl, aryl, heteroaryl, or alkoxy-substituted alkyl. By the term alkyl may be generally meant lower alkyl, that may be from C₁ to C₆ alkyl, or from C₁ to C₄ alkyl. By the term aryl may be meant bicyclic and polycyclic aromatic moieties. By the term heteroaryl may be generally meant aromatic moieties containing one or more heteroatoms selected from the group consisting of sulfur, nitrogen, oxygen, and phosphorus. By the term alkoxy may be generally meant lower alkoxy, that may be from C₁ to C₆ or C₁ to C₄ alkoxy. In another embodiment of the present disclosure, the ammonium cation may be a tetraalkyl ammonium cation, for example tetra-methyl ammonium, tetraethyl ammonium, tetrabutyl ammonium, phenyl trimethylammonium, tertbutyl trimethyl ammonium, and the like.

In another embodiment of the present disclosure, the carbon dioxide release agent may include ammonium carbonate, ammonium bicarbonate, methyl ammonium carbonate, methyl ammonium bicarbonate, tetramethyl ammonium carbonate, tetramethyl ammonium bicarbonate, tetra butyl ammonium carbonate, tetra butyl ammonium bicarbonate, phenyl trimethyl ammonium carbonate, and phenyl trimethyl ammonium bicarbonate.

In another embodiment of the present disclosure, the carbon dioxide release agent, if a carbonate or bicarbonate salt, may include hydrated, and/or anhydrous forms, e.g. monohydrate, dihydrate, tetrahydrate, sesquahydrate, and the like.

In another embodiment of the present disclosure, the carbon dioxide release agent may further comprise from about 1% to about 95% of the composition of the disclosure, whether from about 2% to about 90%, or from about 3% to about 80%, or from about 5% to about 75%, or from about 5% to about 65%, or from about 10% to about 60%, or from about 15% to about 55%, or from about 15% to about 50%, or from about 15% to 45%, or from about 50% to 40%, or from about 20% to 40%, or from about 25% to about 40%, or from about 25% to about 35%, or from about 25% to about 30%, or from about 25% to about 29%, or from about 25% to about 27%, or from about 30% to about 60%, or from about 30% to about 55%, or from about 35% to about 55%, or from about 40% to about 55%, or from about 45% to about 55%, or from about 35% to about 52%, or from about 47% to about 50%, or from about 49% to about 52%, or about 50%. Unless otherwise stated in the present specification and claims, percentages are expressed as weight/weight percentages. Unless otherwise stated in the present specification and claims, any range includes all integers and fractions thereof within the range.

In another embodiment of the present disclosure the carbon dioxide release agent may further comprise, in number selected from the following array of percentages, about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 percent by weight of the composition. This embodiment of the disclosure includes, without limitation, percent weight ranges from any one integer to another integer found in the array of numbers. For example, from the numbers above, the percent weight of the composition may be from about 33% to about 71% by weight, because the numbers are included in the array.

In another embodiment of the present disclosure, the rodenticidally acceptable carrier further comprises a rodenticidally effective bait. By the term rodenticidally effective bait may be meant a foodstuff and/or filler, generally known to a person of ordinary skill in the art in the field of rodent control. The foodstuff and/or filler may comprise a protein and/or a fat and/or a carbohydrate. For example, in one embodiment of the present disclosure, the foodstuff and/or filler may contain one or more of the following features in a rodent-comestibly acceptable form: processed grain byproduct, plant protein product, molasses product, animal protein product, cane molasses, forage product, animal fat, {optionally preserved with bha), calcium carbonate, salt, methionine supplement, chemical preservative, roughage product, Saccharomyces cerevisiae, Lactobacillus acidophilus, Streptococcus faecium, manganous oxide, iron carbonate, zinc oxide, Vitamin E supplement, ferrous sulfate, niacin, Vitamin B12 supplement, biotin, folic acid, riboflavin, copper oxide, pyridoxane hydrochloride, monocalcium phosphate, dicalcium phosphate, cobalt carbonate, L-lysine, copper sulfate, natural and artificial flavors, Vitamin A acetate, D-activated animal sterol (source of Vitamin D3), niacin, calcium pantothenate, menadione dimethylpyrimidinol bisulfate (source of Vitamin K activity), thiamine mononitrate, sodium selenite, choline chloride, zinc sulfate, manganese sulfate, ethylenediamine dihydriodide, and calcium iodate.

In another embodiment of the present disclosure, the foodstuff and/or filler may include one or more of the following features in a rodent-comestibly acceptable form: protein fat, fiber, dry matter, ash, CHO, calcium, phosphorous, potassium, sodium, sulfur, chloride, magnesium, zinc, copper, manganese, iron, iodine, selenium, cobalt, Vitamin A, Vitamin D 3, Vitamin E, Vitamin C, Thiamin B1, Riboflavin B2, Pyridoxine B6, Vitamin B12, biotin, choline, folic acid, niacin, Pantothenic A, linoleic acid, arachidonic acid (20-4) W, linolenic acid (18-3), EPA (20-5) (W•3), DHA22:6 (W•3), arginine, histamine, methionine, cystine, total sulfur amino acids; lysine, which e.g., may or not be available lysine.

In another embodiment of the present disclosure, the rodenticidally effective bait may further comprise a weak acid. By the term weak acid may be generally meant those inorganic and organic acids having a pKₐ in water of from about 3 to about 10, or from about 4 to about 10, or from about 4 to about 9, or from about 5 to about 9, or from about 5 to about 8.

In another embodiment of the present disclosure, the weak acid may be from about 0.01% to about 20%, or from about 0.01% to about 19%, or from about 0.01% to about 18%, or from about 0.01% to about 17%, or from about 0.01% to about 16%, or from about 0.01% to about 15%, or from about 0.01% to about 14%, or from about 0.01% to about 13%, or from about 0.01% to about 12%, or from about 0.01% to about 11%, or from about 0.01% to about 10%, or from about 0.01% to about 9%, or from about 0.01% to about 8%, or from about 0.01% to about 7%, or from about 0.01% to about 6%, or from about 0.01% to about 5%, or from about 0.01% to about 4%, or from about 0.01% to about 3%, or from about 0.01% to about 2%, or from about 0.01% to about 1%, or from about 0.1 to about 1% or from about 0.1% to about 2%, or from about 0.1% to about 3%, or from about 0.5% to about 1%, or from about 0.5% to about 2%, or from about 0.5% to about 3%, or from about 0.5% to about 4%, or from about 0.5% to about 5%, or from about 1% to about 2%, or from about 1% to about 3%, or from about 1% to about 4%, or from about 1% to about 5%, or from about 2% to about 3%, or from about 2% to about 4%, or from about 2% to about 5%, or from about 3% to about 5%, or from about 4% to about 5% of the weak acid.

In another embodiment of the present disclosure, the weak acid may be a fatty acid. By the term fatty acid may be generally meant a carboxylic acid with a long aliphatic tail (chain), the tail being saturated or unsaturated. The fatty acids according to the present disclosure generally may have a chain of an even number of carbon atoms, generally from 4 to 28. The fatty acids according to the present disclosure may be covalently bonded to a glycerine molecule (e.g., a mono, di, or triglyceride) or the fatty acid may be provided as a phospholipid. The fatty acid may be provided as a free fatty acid, that may be with the fatty acid COOH group unbonded to another moiety. The fatty acid may be a short-chain fatty acid (SCFA) e.g., a fatty acid with an aliphatic tail of fewer than six carbons (e.g., butyric acid); or a medium-chain fatty acid (MCFA) e.g. a fatty acid with an aliphatic tail of 6-12 carbons; or a long-chain fatty acid (LCFA) e.g., a fatty acid with an aliphatic tail from 13 to 21 carbons; or a very long chain fatty acids (VLCFA) e.g. a fatty acid with an aliphatic tail longer than 22 carbons.

Examples of fatty acids for use in the present disclosure include acetic acid, propanoic acid, butyric acid, pentanoic acid, hexanoic acid, caprylic acid, capric acid, lauric acid, myristic acid, palmitic acid, stearic acid, arachidic acid, behenic acid, lignoceric acid, cerotic acid, myristoleic acid, palmitoleic acid, sapienic acid, oleic acid, elaidic acid, vaccenic acid, linoleic acid, linoelaidic acid, α-linoleic acid, arachidonic acid, eicosapentaenoic acid, erucic acid, docosahexaenoic acid, and mixtures thereof.

Compositions for oral administration comprise rodenticidally acceptable carriers or coatings and include, for example, tablets, pills, capsules, gels, drenches, medicated feeds, water, dietary supplements, slow-release boluses or other slow-release devices intended to be retained within the gastro-intestinal tract. Any of these may incorporate the carbon dioxide release agent, e.g., contained within micro-capsules or coated with acid-labile or alkali-labile or other rodenticidally acceptable coatings. Feed premixes or concentrates containing the carbon dioxide release agent for use in preparation of the composition, e.g., a bait, drinking water or other materials for consumption by animals may also be used. The rodenticidally acceptable carrier may also comprise an organic or inorganic material, which can be natural or synthetic, and which may be associated with the carbon dioxide release agent and which facilitates its acceptance to the animal. This carrier may be thus generally inert and should be rodenticidally and/or arthropocidally acceptable. The carrier can be solid (e.g., clay, silicates, silica, resins, wax) or liquid (e.g., water, alcohols, ketones, oil solvents, polar aprotic solvents). An example of an oil solvent may be corn oil. An example of a polar aprotic solvent may be dimethyl sulfoxide.

In another embodiment of the present disclosure the molar ratio of the carbon dioxide release agent to the weak acid may be equal to or greater than about 1:1, or from about 1:1 to about 2:1, or from about 1:1 to about 3:1, or from about 1:1 to about 4:1, or from about 1:1 to about 5:1, or from about 1:1 to about 10:1, or from about 1:1 to about 15:1, or from about 1:1 to about 20:1, or from about 1:1 to about 50:1, or about 1:1 to about 100:1 or from about 1:1 to about 200:1; or from about 1:1 to about 300:1; or from about 1:1 to about 400:1.

In another embodiment of the present disclosure the ratio of the carbon dioxide release agent to the weak acid may be such that it creates a large dose of an anionic surfactant sufficient to substantially reduce or destroy gut bacteria or gut flora of the rodent. In another embodiment of the present disclosure, the ratio of the carbon dioxide release agent to the weak acid may be such that the composition attenuates or ceases rodent feeding at a time from about 1 to 7 days after ingestion, or from about 0.25 to 6 days after ingestion, from about 0.25 to 5 days after ingestion, or from about 0.25 to 4 days after ingestion, or from about 0.25 to 3 days after ingestion, from about 0.25 to 2 days after ingestion, or from about 0.25 to 1 day after ingestion, or from about 0.25 to 0.5 day after ingestion, or from about 0.5 day to about 7 days after ingestion, or from about 0.5 to 6 days after ingestion, from about 0.5 to 5 days after ingestion, or from about 0.5 to 4 days after ingestion, or from about 0.5 to 3 days after ingestion, from about 0.5 to 2 days after ingestion, or from about 0.5 to 1 day after ingestion, or from about 1 to about 7 days after ingestion, or from about 1 to about 6 days after ingestion, from about 1 to about 5 days after ingestion, or from about 1 to about 4 days after ingestion, or from about 1 to about 3 days after ingestion, or from about 1 to about 2 days after ingestion, or from about 2 to about 7 days after ingestion, or from about 2 to about 6 days after ingestion, or from about 2 to about 5 days after ingestion, or from about 2 to about 4 days after ingestion, or from about 2 to about 3 days after ingestion, or from about 3 to about 7 days after ingestion, or from about 4 to about 7 days after ingestion, or from about 5 to about 7 days after ingestion, or from about 6 to about 7 days after ingestion, or from about 4 to about 6 days after ingestion, or from about 4 to about 5 days after ingestion As such, the composition of the present disclosure may provide an anti-feeding, rodenticidally effective amount of the composition, or the anionic surfactant formed in vivo.

In another embodiment of the present disclosure the composition may be a flowable composition, that is, applicable by person of ordinary skill in the art at a locus wherein the composition may be deposited via, e.g., a caulking gun at ambient temperature. Typical viscosities of flowable compositions are known to the person of ordinary skill in the art. The composition may be a thixotropic composition, a gel, or undergo a viscosity change when subjected to a shear stress. The composition may be a pseudoplastic composition. After deposition at a locus, the composition may cure into a solid, or semi-solid shape; or may be deposited as a flowable material and subsequently cure or harden in a container designed to hold and mold the flowable composition. Such techniques are understood and known by those of skill in the art and/or skill in the art in formulation chemistry, or rheology.

In another embodiment of the present disclosure, the composition may be a solid, e.g. a shaped solid. By the term shaped may be generally meant a form which may be an acceptably shaped bait to those of ordinary skill in the art, e.g. a pellet, a granule, a pill, a cylinder, or any other like shape. In a further embodiment of the present disclosure the shaped article may be unsuitable for swallowing by a human, e.g., a child or an adult. The shaped article may have a density acceptable to a person of ordinary skill, or comestibly acceptable for a rodent, for example from about 1 to 10 g/mL.

The composition may, in another embodiment, have a pH of from about 7 to 14, or from about 7 to 11 or, or from about 7 to 10, or from about 7 to 9, or from about 7 to 8, or from about 7 to 7.5. In any case, taken as a whole, and dissolved or suspended in water at a concentration from 0.1 to 1 M, the mixture may have a pH greater than 7.

The composition may have water content of from about 1% to about 30%. In another embodiment of the present disclosure the percent water by weight may be number selected from the following array of percentages, about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, percent by weight of the composition. This embodiment of the disclosure includes, without limitation, percent weight ranges from any one integer to another integer found in the array of numbers. For example, from the numbers above, the percent weight of the water may be from about 3% to about 11% by weight, because the numbers are included in the array.

In another embodiment of the present disclosure the composition further comprises a rodenticidally effective amount of a second rodenticidal active ingredient. The second rodenticidal active ingredient may be an anticoagulant, a metal phosphide, a hypercalcemia agent or other chemical poison known to those of skill in the art. The anticoagulant may be a first generation rodenticidal anticoagulant, or a second-generation rodenticidal anticoagulant. A typical first generation rodenticidal anticoagulant would have a concentration in the composition of from 0.0001% to about 0.1%; or from about 0.005% to about 0.1%; and atypical second-generation rodenticidal anticoagulant would have a concentration in the composition of from about 0.00001% to about 0.01% or from about 0.0001% to about 0.005%; or from about 0.001% to about 0.005%.

In another embodiment of the present disclosure the first and/or the second generation anticoagulant may be provided in the composition in part per million (ppm) amount selected from the following array of numbers: 0.0010, 0.0011, 0.0012, 0.0013, 0.0014, 0.0015, 0.0016, 0.0017, 0.0018, 0.0019, 0.0020, 0.0021, 0.0022, 0.0023, 0.0024, 0.0025, 0.0026, 0.0027, 0.0028, 0.0029, 0.0030, 0.0031, 0.0032, 0.0033, 0.0034, 0.0035, 0.0036, 0.0037, 0.0038, 0.0039, 0.0040, 0.0041, 0.0042, 0.0043, 0.0044, 0.0045, 0.0046, 0.0047, 0.0048, 0.0049, 0.0050, 0.0051, 0.0052, 0.0053, 0.0054, 0.0055, 0.0056, 0.0057, 0.0058, 0.0059, 0.0060, 0.0061, 0.0062, 0.0063, 0.0064, 0.0065, 0.0066, 0.0067, 0.0068, 0.0069, 0.0070, 0.0071, 0.0072, 0.0073, 0.0074, 0.0075, 0.0076, 0.0077, 0.0078, 0.0079, 0.0080, 0.0081, 0.0082, 0.0083, 0.0084, 0.0085, 0.0086, 0.0087, 0.0088, 0.0089, 0.0090, 0.0091, 0.0092, 0.0093, 0.0094, 0.0095, 0.0096, 0.0097, 0.0098, 0.0099, 0.010, 0.011, 0.012, 0.013, 0.014, 0.015, 0.016, 0.017, 0.018, 0.019, 0.020, 0.021, 0.022, 0.023, 0.024, 0.025, 0.026, 0.027, 0.028, 0.029, 0.030, 0.031, 0.032, 0.033, 0.034, 0.035, 0.036, 0.037, 0.038, 0.039, 0.040, 0.041, 0.042, 0.043, 0.044, 0.045, 0.046, 0.047, 0.048, 0.049, 0.050, 0.051, 0.052, 0.053, 0.054, 0.055, 0.056, 0.057, 0.058, 0.059, 0.060, 0.061, 0.062, 0.063, 0.064, 0.065, 0.066, 0.067, 0.068, 0.069, 0.070, 0.071, 0.072, 0.073, 0.074, 0.075, 0.076, 0.077, 0.078, 0.079, 0.080, 0.081, 0.082, 0.083, 0.084, 0.085, 0.086, 0.087, 0.088, 0.089, 0.090, 0.091, 0.092, 0.093, 0.094, 0.095, 0.096, 0.097, 0.098, 0.099, 0.1, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.44, 0.45, 0.46, 0.47, 0.48, 0.49, 0.50, 0.51, 0.52, 0.53, 0.54, 0.55, 0.56, 0.57, 0.58, 0.59, 0.60, 0.61, 0.62, 0.63, 0.64, 0.65, 0.66, 0.67, 0.68, 0.69, 0.70, 0.71, 0.72, 0.73, 0.74, 0.75, 0.76, 0.77, 0.78, 0.79, 0.80, 0.81, 0.82, 0.83, 0.84, 0.85, 0.86, 0.87, 0.88, 0.89, 0.90, 0.91, 0.92, 0.93, 0.94, 0.95, 0.96, 0.97, 0.98, 0.99, 1.00, 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.20, 1.21, 1.22, 1.23, 1.24, 1.25, 1.26, 1.27, 1.28, 1.29, 1.30, 1.31, 1.32, 1.33, 1.34, 1.35, 1.36, 1.37, 1.38, 1.39, 1.40, 1.41, 1.42, 1.43, 1.44, 1.45, 1.46, 1.47, 1.48, 1.49, 1.50, 1.51, 1.52, 1.53, 1.54, 1.55, 1.56, 1.57, 1.58, 1.59, 1.60, 1.61, 1.62, 1.63, 1.64, 1.65, 1.66, 1.67, 1.68, 1.69, 1.70, 1.71, 1.72, 1.73, 1.74, 1.75, 1.76, 1.77, 1.78, 1.79, 1.80, 1.81, 1.82, 1.83, 1.84, 1.85, 1.86, 1.87, 1.88, 1.89, 1.90, 1.91, 1.92, 1.93, 1.94, 1.95, 1.96, 1.97, 1.98, 1.99, 2.00, 2.01, 2.02, 2.03, 2.04, 2.05, 2.06, 2.07, 2.08, 2.09, 2.10, 2.11, 2.12, 2.13, 2.14, 2.15, 2.16, 2.17, 2.18, 2.19, 2.20, 2.21, 2.22, 2.23, 2.24, 2.25, 2.26, 2.27, 2.28, 2.29, 2.30, 2.31, 2.32, 2.33, 2.34, 2.35, 2.36, 2.37, 2.38, 2.39, 2.40, 2.41, 2.42, 2.43, 2.44, 2.45, 2.46, 2.47, 2.48, 2.49, 2.50, 2.51, 2.52, 2.53, 2.54, 2.55, 2.56, 2.57, 2.58, 2.59, 2.60, 2.61, 2.62, 2.63, 2.64, 2.65, 2.66, 2.67, 2.68, 2.69, 2.70, 2.71, 2.72, 2.73, 2.74, 2.75, 2.76, 2.77, 2.78, 2.79, 2.80, 2.81, 2.82, 2.83, 2.84, 2.85, 2.86, 2.87, 2.88, 2.89, 2.90, 2.91, 2.92, 2.93, 2.94, 2.95, 2.96, 2.97, 2.98, 2.99, 3.00, 3.01, 3.02, 3.03, 3.04, 3.05, 3.06, 3.07, 3.08, 3.09, 3.10, 3.11, 3.12, 3.13, 3.14, 3.15, 3.16, 3.17, 3.18, 3.19, 3.20, 3.21, 3.22, 3.23, 3.24, 3.25, 3.26, 3.27, 3.28, 3.29, 3.30, 3.31, 3.32, 3.33, 3.34, 3.35, 3.36, 3.37, 3.38, 3.39, 3.40, 3.41, 3.42, 3.43, 3.44, 3.45, 3.46, 3.47, 3.48, 3.49, 3.50, 3.51, 3.52, 3.53, 3.54, 3.55, 3.56, 3.57, 3.58, 3.59, 3.60, 3.61, 3.62, 3.63, 3.64, 3.65, 3.66, 3.67, 3.68, 3.69, 3.70, 3.71, 3.72, 3.73, 3.74, 3.75, 3.76, 3.77, 3.78, 3.79, 3.80, 3.81, 3.82, 3.83, 3.84, 3.85, 3.86, 3.87, 3.88, 3.89, 3.90, 3.91, 3.92, 3.93, 3.94, 3.95, 3.96, 3.97, 3.98, 3.99, 4.00, 4.01, 4.02, 4.03, 4.04, 4.05, 4.06, 4.07, 4.08, 4.09, 4.10, 4.11, 4.12, 4.13, 4.14, 4.15, 4.16, 4.17, 4.18, 4.19, 4.20, 4.21, 4.22, 4.23, 4.24, 4.25, 4.26, 4.27, 4.28, 4.29, 4.30, 4.31, 4.32, 4.33, 4.34, 4.35, 4.36, 4.37, 4.38, 4.39, 4.40, 4.41, 4.42, 4.43, 4.44, 4.45, 4.46, 4.47, 4.48, 4.49, 4.50, 4.51, 4.52, 4.53, 4.54, 4.55, 4.56, 4.57, 4.58, 4.59, 4.60, 4.61, 4.62, 4.63, 4.64, 4.65, 4.66, 4.67, 4.68, 4.69, 4.70, 4.71, 4.72, 4.73, 4.74, 4.75, 4.76, 4.77, 4.78, 4.79, 4.80, 4.81, 4.82, 4.83, 4.84, 4.85, 4.86, 4.87, 4.88, 4.89, 4.90, 4.91, 4.92, 4.93, 4.94, 4.95, 4.96, 4.97, 4.98, 4.99, 5.00, 5.01, 5.02, 5.03, 5.04, 5.05, 5.06, 5.07, 5.08, 5.09, 5.10, 5.11, 5.12, 5.13, 5.14, 5.15, 5.16, 5.17, 5.18, 5.19, 5.20, 5.21, 5.22, 5.23, 5.24, 5.25, 5.26, 5.27, 5.28, 5.29, 5.30, 5.31, 5.32, 5.33, 5.34, 5.35, 5.36, 5.37, 5.38, 5.39, 5.40, 5.41, 5.42, 5.43, 5.44, 5.45, 5.46, 5.47, 5.48, 5.49, 5.50, 5.51, 5.52, 5.53, 5.54, 5.55, 5.56, 5.57, 5.58, 5.59, 5.60, 5.61, 5.62, 5.63, 5.64, 5.65, 5.66, 5.67, 5.68, 5.69, 5.70, 5.71, 5.72, 5.73, 5.74, 5.75, 5.76, 5.77, 5.78, 5.79, 5.80, 5.81, 5.82, 5.83, 5.84, 5.85, 5.86, 5.87, 5.88, 5.89, 5.90, 5.91, 5.92, 5.93, 5.94, 5.95, 5.96, 5.97, 5.98, 5.99, 6.00, 6.01, 6.02, 6.03, 6.04, 6.05, 6.06, 6.07, 6.08, 6.09, 6.10, 6.11, 6.12, 6.13, 6.14, 6.15, 6.16, 6.17, 6.18, 6.19, 6.20, 6.21, 6.22, 6.23, 6.24, 6.25, 6.26, 6.27, 6.28, 6.29, 6.30, 6.31, 6.32, 6.33, 6.34, 6.35, 6.36, 6.37, 6.38, 6.39, 6.40, 6.41, 6.42, 6.43, 6.44, 6.45, 6.46, 6.47, 6.48, 6.49, 6.50, 6.51, 6.52, 6.53, 6.54, 6.55, 6.56, 6.57, 6.58, 6.59, 6.60, 6.61, 6.62, 6.63, 6.64, 6.65, 6.66, 6.67, 6.68, 6.69, 6.70, 6.71, 6.72, 6.73, 6.74, 6.75, 6.76, 6.77, 6.78, 6.79, 6.80, 6.81, 6.82, 6.83, 6.84, 6.85, 6.86, 6.87, 6.88, 6.89, 6.90, 6.91, 6.92, 6.93, 6.94, 6.95, 6.96, 6.97, 6.98, 6.99, 7.00, 7.01, 7.02, 7.03, 7.04, 7.05, 7.06, 7.07, 7.08, 7.09, 7.10, 7.11, 7.12, 7.13, 7.14, 7.15, 7.16, 7.17, 7.18, 7.19, 7.20, 7.21, 7.22, 7.23, 7.24, 7.25, 7.26, 7.27, 7.28, 7.29, 7.30, 7.31, 7.32, 7.33, 7.34, 7.35, 7.36, 7.37, 7.38, 7.39, 7.40, 7.41, 7.42, 7.43, 7.44, 7.45, 7.46, 7.47, 7.48, 7.49, 7.50, 7.51, 7.52, 7.53, 7.54, 7.55, 7.56, 7.57, 7.58, 7.59, 7.60, 7.61, 7.62, 7.63, 7.64, 7.65, 7.66, 7.67, 7.68, 7.69, 7.70, 7.71, 7.72, 7.73, 7.74, 7.75, 7.76, 7.77, 7.78, 7.79, 7.80, 7.81, 7.82, 7.83, 7.84, 7.85, 7.86, 7.87, 7.88, 7.89, 7.90, 7.91, 7.92, 7.93, 7.94, 7.95, 7.96, 7.97, 7.98, 7.99, 8.00, 8.01, 8.02, 8.03, 8.04, 8.05, 8.06, 8.07, 8.08, 8.09, 8.10, 8.11, 8.12, 8.13, 8.14, 8.15, 8.16, 8.17, 8.18, 8.19, 8.20, 8.21, 8.22, 8.23, 8.24, 8.25, 8.26, 8.27, 8.28, 8.29, 8.30, 8.31, 8.32, 8.33, 8.34, 8.35, 8.36, 8.37, 8.38, 8.39, 8.40, 8.41, 8.42, 8.43, 8.44, 8.45, 8.46, 8.47, 8.48, 8.49, 8.50, 8.51, 8.52, 8.53, 8.54, 8.55, 8.56, 8.57, 8.58, 8.59, 8.60, 8.61, 8.62, 8.63, 8.64, 8.65, 8.66, 8.67, 8.68, 8.69, 8.70, 8.71, 8.72, 8.73, 8.74, 8.75, 8.76, 8.77, 8.78, 8.79, 8.80, 8.81, 8.82, 8.83, 8.84, 8.85, 8.86, 8.87, 8.88, 8.89, 8.90, 8.91, 8.92, 8.93, 8.94, 8.95, 8.96, 8.97, 8.98, 8.99, 9.00, 9.01, 9.02, 9.03, 9.04, 9.05, 9.06, 9.07, 9.08, 9.09, 9.10, 9.11, 9.12, 9.13, 9.14, 9.15, 9.16, 9.17, 9.18, 9.19, 9.20, 9.21, 9.22, 9.23, 9.24, 9.25, 9.26, 9.27, 9.28, 9.29, 9.30, 9.31, 9.32, 9.33, 9.34, 9.35, 9.36, 9.37, 9.38, 9.39, 9.40, 9.41, 9.42, 9.43, 9.44, 9.45, 9.46, 9.47, 9.48, 9.49, 9.50, 9.51, 9.52, 9.53, 9.54, 9.55, 9.56, 9.57, 9.58, 9.59, 9.60, 9.61, 9.62, 9.63, 9.64, 9.65, 9.66, 9.67, 9.68, 9.69, 9.70, 9.71, 9.72, 9.73, 9.74, 9.75, 9.76, 9.77, 9.78, 9.79, 9.80, 9.81, 9.82, 9.83, 9.84, 9.85, 9.86, 9.87, 9.88, 9.89, 9.90, 9.91, 9.92, 9.93, 9.94, 9.95, 9.96, 9.97, 9.98, 9.99, 10.00, 10.01, 10.02, 10.03, 10.04, 10.05, 10.06, 10.07, 10.08, 10.09, 10.10, 10.11, 10.12, 10.13, 10.14, 10.15, 10.16, 10.17, 10.18, 10.19, 10.20, 10.21, 10.22, 10.23, 10.24, 10.25, 10.26, 10.27, 10.28, 10.29, 10.30, 10.31, 10.32, 10.33, 10.34, 10.35, 10.36, 10.37, 10.38, 10.39, 10.40, 10.41, 10.42, 10.43, 10.44, 10.45, 10.46, 10.47, 10.48, 10.49, 10.50, 10.51, 10.52, 10.53, 10.54, 10.55, 10.56, 10.57, 10.58, 10.59, 10.60, 10.61, 10.62, 10.63, 10.64, 10.65, 10.66, 10.67, 10.68, 10.69, 10.70, 10.71, 10.72, 10.73, 10.74, 10.75, 10.76, 10.77, 10.78, 10.79, 10.80, 10.81, 10.82, 10.83, 10.84, 10.85, 10.86, 10.87, 10.88, 10.89, 10.90, 10.91, 10.92, 10.93, 10.94, 10.95, 10.96, 10.97, 10.98, 10.99, 11.00, 11.01, 11.02, 1.03, 11.04, 11.05, 11.06, 1.07, 11.08, 11.09, 11.10, 11.11, 11.12, 11.13, 11.14, 11.15, 11.16, 11.17, 11.18, 11.19, 11.20, 11.21, 11.22, 11.23, 11.24, 11.25, 11.26, 11.27, 11.28, 11.29, 11.30, 11.31, 11.32, 11.33, 11.34, 11.35, 11.36, 11.37, 11.38, 11.39, 11.40, 11.41, 11.42, 11.43, 11.44, 11.45, 11.46, 11.47, 11.48, 11.49, 11.50, 11.51, 11.52, 11.53, 11.54, 11.55, 11.56, 11.57, 11.58, 11.59, 11.60, 11.61, 11.62, 11.63, 11.64, 11.65, 11.66, 11.67, 11.68, 11.69, 11.70, 11.71, 11.72, 11.73, 11.74, 11.75, 11.76, 11.77, 11.78, 11.79, 11.80, 11.81, 11.82, 11.83, 11.84, 11.85, 11.86, 11.87, 11.88, 11.89, 11.90, 11.91, 11.92, 11.93, 11.94, 11.95, 11.96, 11.97, 11.98, 11.99, 12.00, 12.01, 12.02, 12.03, 12.04, 12.05, 12.06, 12.07, 12.08, 12.09, 12.10, 12.11, 12.12, 12.13, 12.14, 12.15, 12.16, 12.17, 12.18, 12.19, 12.20, 12.21, 12.22, 12.23, 12.24, 12.25, 12.26, 12.27, 12.28, 12.29, 12.30, 12.31, 12.32, 12.33, 12.34, 12.35, 12.36, 12.37, 12.38, 12.39, 12.40, 12.41, 12.42, 12.43, 12.44, 12.45, 12.46, 12.47, 12.48, 12.49, 12.50, 12.51, 12.52, 12.53, 12.54, 12.55, 12.56, 12.57, 12.58, 12.59, 12.60, 12.61, 12.62, 12.63, 12.64, 12.65, 12.66, 12.67, 12.68, 12.69, 12.70, 12.71, 12.72, 12.73, 12.74, 12.75, 12.76, 12.77, 12.78, 12.79, 12.80, 12.81, 12.82, 12.83, 12.84, 12.85, 12.86, 12.87, 12.88, 12.89, 12.90, 12.91, 12.92, 12.93, 12.94, 12.95, 12.96, 12.97, 12.98, 12.99, 13.00, 13.01, 13.02, 13.03, 13.04, 13.05, 13.06, 13.07, 13.08, 13.09, 13.10, 13.11, 13.12, 13.13, 13.14, 13.15, 13.16, 13.17, 13.18, 13.19, 13.20, 13.21, 13.22, 13.23, 13.24, 13.25, 13.26, 13.27, 13.28, 13.29, 13.30, 13.31, 13.32, 13.33, 13.34, 13.35, 13.36, 13.37, 13.38, 13.39, 13.40, 13.41, 13.42, 13.43, 13.44, 13.45, 13.46, 13.47, 13.48, 13.49, 13.50, 13.51, 13.52, 13.53, 13.54, 13.55, 13.56, 13.57, 13.58, 13.59, 13.60, 13.61, 13.62, 13.63, 13.64, 13.65, 13.66, 13.67, 13.68, 13.69, 13.70, 13.71, 13.72, 13.73, 13.74, 13.75, 13.76, 13.77, 13.78, 13.79, 13.80, 13.81, 13.82, 13.83, 13.84, 13.85, 13.86, 13.87, 13.88, 13.89, 13.90, 13.91, 13.92, 13.93, 13.94, 13.95, 13.96, 13.97, 13.98, 13.99, 14.00, 14.01, 14.02, 14.03, 14.04, 14.05, 14.06, 14.07, 14.08, 14.09, 14.10, 14.11, 14.12, 14.13, 14.14, 14.15, 14.16, 14.17, 14.18, 14.19, 14.20, 14.21, 14.22, 14.23, 14.24, 14.25, 14.26, 14.27, 14.28, 14.29, 14.30, 14.31, 14.32, 14.33, 14.34, 14.35, 14.36, 14.37, 14.38, 14.39, 14.40, 14.41, 14.42, 14.43, 14.44, 14.45, 14.46, 14.47, 14.48, 14.49, 14.50, 14.51, 14.52, 14.53, 14.54, 14.55, 14.56, 14.57, 14.58, 14.59, 14.60, 14.61, 14.62, 14.63, 14.64, 14.65, 14.66, 14.67, 14.68, 14.69, 14.70, 14.71, 14.72, 14.73, 14.74, 14.75, 14.76, 14.77, 14.78, 14.79, 14.80, 14.81, 14.82, 14.83, 14.84, 14.85, 14.86, 14.87, 14.88, 14.89, 14.90, 14.91, 14.92, 14.93, 14.94, 14.95, 14.96, 14.97, 14.98, 14.99, 15.00, 15.01, 15.02, 15.03, 15.04, 15.05, 15.06, 15.07, 15.08, 15.09, 15.10, 15.11, 15.12, 15.13, 15.14, 15.15, 15.16, 15.17, 15.18, 15.19, 15.20, 15.21, 15.22, 15.23, 15.24, 15.25, 15.26, 15.27, 15.28, 15.29, 15.30, 15.31, 15.32, 15.33, 15.34, 15.35, 15.36, 15.37, 15.38, 15.39, 15.40, 15.41, 15.42, 15.43, 15.44, 15.45, 15.46, 15.47, 15.48, 15.49, 15.50, 15.51, 15.52, 15.53, 15.54, 15.55, 15.56, 15.57, 15.58, 15.59, 15.60, 15.61, 15.62, 15.63, 15.64, 15.65, 15.66, 15.67, 15.68, 15.69, 15.70, 15.71, 15.72, 15.73, 15.74, 15.75, 15.76, 15.77, 15.78, 15.79, 15.80, 15.81, 15.82, 15.83, 15.84, 15.85, 15.86, 15.87, 15.88, 15.89, 15.90, 15.91, 15.92, 15.93, 15.94, 15.95, 15.96, 15.97, 15.98, 15.99, 16.00, 16.01, 16.02, 16.03, 16.04, 16.05, 16.06, 16.07, 16.08, 16.09, 16.10, 16.11, 16.12, 16.13, 16.14, 16.15, 16.16, 16.17, 16.18, 16.19, 16.20, 16.21, 16.22, 16.23, 16.24, 16.25, 16.26, 16.27, 16.28, 16.29, 16.30, 16.31, 16.32, 16.33, 16.34, 16.35, 16.36, 16.37, 16.38, 16.39, 16.40, 16.41, 16.42, 16.43, 16.44, 16.45, 16.46, 16.47, 16.48, 16.49, 16.50, 16.51, 16.52, 16.53, 16.54, 16.55, 16.56, 16.57, 16.58, 16.59, 16.60, 16.61, 16.62, 16.63, 16.64, 16.65, 16.66, 16.67, 16.68, 16.69, 16.70, 16.71, 16.72, 16.73, 16.74, 16.75, 16.76, 16.77, 16.78, 16.79, 16.80, 16.81, 16.82, 16.83, 16.84, 16.85, 16.86, 16.87, 16.88, 16.89, 16.90, 16.91, 16.92, 16.93, 16.94, 16.95, 16.96, 16.97, 16.98, 16.99, 17.00, 17.01, 17.02, 17.03, 17.04, 17.05, 17.06, 17.07, 17.08, 17.09, 17.10, 17.11, 17.12, 17.13, 17.14, 17.15, 17.16, 17.17, 17.18, 17.19, 17.20, 17.21, 17.22, 17.23, 17.24, 17.25, 17.26, 17.27, 17.28, 17.29, 17.30, 17.31, 17.32, 17.33, 17.34, 17.35, 17.36, 17.37, 17.38, 17.39, 17.40, 17.41, 17.42, 17.43, 17.44, 17.45, 17.46, 17.47, 17.48, 17.49, 17.50, 17.51, 17.52, 17.53, 17.54, 17.55, 17.56, 17.57, 17.58, 17.59, 17.60, 17.61, 17.62, 17.63, 17.64, 17.65, 17.66, 17.67, 17.68, 17.69, 17.70, 17.71, 17.72, 17.73, 17.74, 17.75, 17.76, 17.77, 17.78, 17.79, 17.80, 17.81, 17.82, 17.83, 17.84, 17.85, 17.86, 17.87, 17.88, 17.89, 17.90, 17.91, 17.92, 17.93, 17.94, 17.95, 17.96, 17.97, 17.98, 17.99, 18.00, 18.01, 18.02, 18.03, 18.04, 18.05, 18.06, 18.07, 18.08, 18.09, 18.10, 18.11, 18.12, 18.13, 18.14, 18.15, 18.16, 18.17, 18.18, 18.19, 18.20, 18.21, 18.22, 18.23, 18.24, 18.25, 18.26, 18.27, 18.28, 18.29, 18.30, 18.31, 18.32, 18.33, 18.34, 18.35, 18.36, 18.37, 18.38, 18.39, 18.40, 18.41, 18.42, 18.43, 18.44, 18.45, 18.46, 18.47, 18.48, 18.49, 18.50, 18.51, 18.52, 18.53, 18.54, 18.55, 18.56, 18.57, 18.58, 18.59, 18.60, 18.61, 18.62, 18.63, 18.64, 18.65, 18.66, 18.67, 18.68, 18.69, 18.70, 18.71, 18.72, 18.73, 18.74, 18.75, 18.76, 18.77, 18.78, 18.79, 18.80, 18.81, 18.82, 18.83, 18.84, 18.85, 18.86, 18.87, 18.88, 18.89, 18.90, 18.91, 18.92, 18.93, 18.94, 18.95, 18.96, 18.97, 18.98, 18.99, 19.00, 19.01, 19.02, 19.03, 19.04, 19.05, 19.06, 19.07, 19.08, 19.09, 19.10, 19.11, 19.12, 19.13, 19.14, 19.15, 19.16, 19.17, 19.18, 19.19, 19.20, 19.21, 19.22, 19.23, 19.24, 19.25, 19.26, 19.27, 19.28, 19.29, 19.30, 19.31, 19.32, 19.33, 19.34, 19.35, 19.36, 19.37, 19.38, 19.39, 19.40, 19.41, 19.42, 19.43, 19.44, 19.45, 19.46, 19.47, 19.48, 19.49, 19.50, 19.51, 19.52, 19.53, 19.54, 19.55, 19.56, 19.57, 19.58, 19.59, 19.60, 19.61, 19.62, 19.63, 19.64, 19.65, 19.66, 19.67, 19.68, 19.69, 19.70, 19.71, 19.72, 19.73, 19.74, 19.75, 19.76, 19.77, 19.78, 19.79, 19.80, 19.81, 19.82, 19.83, 19.84, 19.85, 19.86, 19.87, 19.88, 19.89, 19.90, 19.91, 19.92, 19.93, 19.94, 19.95, 19.96, 19.97, 19.98, 19.99, 20.00, 20.01, 20.02, 20.03, 20.04, 20.05, 20.06, 20.07, 20.08, 20.09, 20.10, 20.11, 20.12, 20.13, 20.14, 20.15, 20.16, 20.17, 20.18, 20.19, 20.20, 20.21, 20.22, 20.23, 20.24, 20.25, 20.26, 20.27, 20.28, 20.29, 20.30, 20.31, 20.32, 20.33, 20.34, 20.35, 20.36, 20.37, 20.38, 20.39, 20.40, 20.41, 20.42, 20.43, 20.44, 20.45, 20.46, 20.47, 20.48, 20.49, 20.50, 20.51, 20.52, 20.53, 20.54, 20.55, 20.56, 20.57, 20.58, 20.59, 20.60, 20.61, 20.62, 20.63, 20.64, 20.65, 20.66, 20.67, 20.68, 20.69, 20.70, 20.71, 20.72, 20.73, 20.74, 20.75, 20.76, 20.77, 20.78, 20.79, 20.80, 20.81, 20.82, 20.83, 20.84, 20.85, 20.86, 20.87, 20.88, 20.89, 20.90, 20.91, 20.92, 20.93, 20.94, 20.95, 20.96, 20.97, 20.98, 20.99, 21.00, 21.01, 21.02, 2.03, 21.04, 21.05, 21.06, 2.07, 21.08, 21.09, 21.10, 21.11, 21.12, 21.13, 21.14, 21.15, 21.16, 21.17, 21.18, 21.19, 21.20, 21.21, 21.22, 21.23, 21.24, 21.25, 21.26, 21.27, 21.28, 21.29, 21.30, 21.31, 21.32, 21.33, 21.34, 21.35, 21.36, 21.37, 21.38, 21.39, 21.40, 21.41, 21.42, 21.43, 21.44, 21.45, 21.46, 21.47, 21.48, 21.49, 21.50, 21.51, 21.52, 21.53, 21.54, 21.55, 21.56, 21.57, 21.58, 21.59, 21.60, 21.61, 21.62, 21.63, 21.64, 21.65, 21.66, 21.67, 21.68, 21.69, 21.70, 21.71, 21.72, 21.73, 21.74, 21.75, 21.76, 21.77, 21.78, 21.79, 21.80, 21.81, 21.82, 21.83, 21.84, 21.85, 21.86, 21.87, 21.88, 21.89, 21.90, 21.91, 21.92, 21.93, 21.94, 21.95, 21.96, 21.97, 21.98, 21.99, 22.00, 22.01, 22.02, 22.03, 22.04, 22.05, 22.06, 22.07, 22.08, 22.09, 22.10, 22.11, 22.12, 22.13, 22.14, 22.15, 22.16, 22.17, 22.18, 22.19, 22.20, 22.21, 22.22, 22.23, 22.24, 22.25, 22.26, 22.27, 22.28, 22.29, 22.30, 22.31, 22.32, 22.33, 22.34, 22.35, 22.36, 22.37, 22.38, 22.39, 22.40, 22.41, 22.42, 22.43, 22.44, 22.45, 22.46, 22.47, 22.48, 22.49, 22.50, 22.51, 22.52, 22.53, 22.54, 22.55, 22.56, 22.57, 22.58, 22.59, 22.60, 22.61, 22.62, 22.63, 22.64, 22.65, 22.66, 22.67, 22.68, 22.69, 22.70, 22.71, 22.72, 22.73, 22.74, 22.75, 22.76, 22.77, 22.78, 22.79, 22.80, 22.81, 22.82, 22.83, 22.84, 22.85, 22.86, 22.87, 22.88, 22.89, 22.90, 22.91, 22.92, 22.93, 22.94, 22.95, 22.96, 22.97, 22.98, 22.99, 23.00, 23.01, 23.02, 23.03, 23.04, 23.05, 23.06, 23.07, 23.08, 23.09, 23.10, 23.11, 23.12, 23.13, 23.14, 23.15, 23.16, 23.17, 23.18, 23.19, 23.20, 23.21, 23.22, 23.23, 23.24, 23.25, 23.26, 23.27, 23.28, 23.29, 23.30, 23.31, 23.32, 23.33, 23.34, 23.35, 23.36, 23.37, 23.38, 23.39, 23.40, 23.41, 23.42, 23.43, 23.44, 23.45, 23.46, 23.47, 23.48, 23.49, 23.50, 23.51, 23.52, 23.53, 23.54, 23.55, 23.56, 23.57, 23.58, 23.59, 23.60, 23.61, 23.62, 23.63, 23.64, 23.65, 23.66, 23.67, 23.68, 23.69, 23.70, 23.71, 23.72, 23.73, 23.74, 23.75, 23.76, 23.77, 23.78, 23.79, 23.80, 23.81, 23.82, 23.83, 23.84, 23.85, 23.86, 23.87, 23.88, 23.89, 23.90, 23.91, 23.92, 23.93, 23.94, 23.95, 23.96, 23.97, 23.98, 23.99, 24.00, 24.01, 24.02, 24.03, 24.04, 24.05, 24.06, 24.07, 24.08, 24.09, 24.10, 24.11, 24.12, 24.13, 24.14, 24.15, 24.16, 24.17, 24.18, 24.19, 24.20, 24.21, 24.22, 24.23, 24.24, 24.25, 24.26, 24.27, 24.28, 24.29, 24.30, 24.31, 24.32, 24.33, 24.34, 24.35, 24.36, 24.37, 24.38, 24.39, 24.40, 24.41, 24.42, 24.43, 24.44, 24.45, 24.46, 24.47, 24.48, 24.49, 24.50, 24.51, 24.52, 24.53, 24.54, 24.55, 24.56, 24.57, 24.58, 24.59, 24.60, 24.61, 24.62, 24.63, 24.64, 24.65, 24.66, 24.67, 24.68, 24.69, 24.70, 24.71, 24.72, 24.73, 24.74, 24.75, 24.76, 24.77, 24.78, 24.79, 24.80, 24.81, 24.82, 24.83, 24.84, 24.85, 24.86, 24.87, 24.88, 24.89, 24.90, 24.91, 24.92, 24.93, 24.94, 24.95, 24.96, 24.97, 24.98, 24.99, 25.00, 25.01, 25.02, 25.03, 25.04, 25.05, 25.06, 25.07, 25.08, 25.09, 25.10, 25.11, 25.12, 25.13, 25.14, 25.15, 25.16, 25.17, 25.18, 25.19, 25.20, 25.21, 25.22, 25.23, 25.24, 25.25, 25.26, 25.27, 25.28, 25.29, 25.30, 25.31, 25.32, 25.33, 25.34, 25.35, 25.36, 25.37, 25.38, 25.39, 25.40, 25.41, 25.42, 25.43, 25.44, 25.45, 25.46, 25.47, 25.48, 25.49, 25.50, 25.51, 25.52, 25.53, 25.54, 25.55, 25.56, 25.57, 25.58, 25.59, 25.60, 25.61, 25.62, 25.63, 25.64, 25.65, 25.66, 25.67, 25.68, 25.69, 25.70, 25.71, 25.72, 25.73, 25.74, 25.75, 25.76, 25.77, 25.78, 25.79, 25.80, 25.81, 25.82, 25.83, 25.84, 25.85, 25.86, 25.87, 25.88, 25.89, 25.90, 25.91, 25.92, 25.93, 25.94, 25.95, 25.96, 25.97, 25.98, 25.99, 26.00, 26.01, 26.02, 26.03, 26.04, 26.05, 26.06, 26.07, 26.08, 26.09, 26.10, 26.11, 26.12, 26.13, 26.14, 26.15, 26.16, 26.17, 26.18, 26.19, 26.20, 26.21, 26.22, 26.23, 26.24, 26.25, 26.26, 26.27, 26.28, 26.29, 26.30, 26.31, 26.32, 26.33, 26.34, 26.35, 26.36, 26.37, 26.38, 26.39, 26.40, 26.41, 26.42, 26.43, 26.44, 26.45, 26.46, 26.47, 26.48, 26.49, 26.50, 26.51, 26.52, 26.53, 26.54, 26.55, 26.56, 26.57, 26.58, 26.59, 26.60, 26.61, 26.62, 26.63, 26.64, 26.65, 26.66, 26.67, 26.68, 26.69, 26.70, 26.71, 26.72, 26.73, 26.74, 26.75, 26.76, 26.77, 26.78, 26.79, 26.80, 26.81, 26.82, 26.83, 26.84, 26.85, 26.86, 26.87, 26.88, 26.89, 26.90, 26.91, 26.92, 26.93, 26.94, 26.95, 26.96, 26.97, 26.98, 26.99, 27.00, 27.01, 27.02, 27.03, 27.04, 27.05, 27.06, 27.07, 27.08, 27.09, 27.10, 27.11, 27.12, 27.13, 27.14, 27.15, 27.16, 27.17, 27.18, 27.19, 27.20, 27.21, 27.22, 27.23, 27.24, 27.25, 27.26, 27.27, 27.28, 27.29, 27.30, 27.31, 27.32, 27.33, 27.34, 27.35, 27.36, 27.37, 27.38, 27.39, 27.40, 27.41, 27.42, 27.43, 27.44, 27.45, 27.46, 27.47, 27.48, 27.49, 27.50, 27.51, 27.52, 27.53, 27.54, 27.55, 27.56, 27.57, 27.58, 27.59, 27.60, 27.61, 27.62, 27.63, 27.64, 27.65, 27.66, 27.67, 27.68, 27.69, 27.70, 27.71, 27.72, 27.73, 27.74, 27.75, 27.76, 27.77, 27.78, 27.79, 27.80, 27.81, 27.82, 27.83, 27.84, 27.85, 27.86, 27.87, 27.88, 27.89, 27.90, 27.91, 27.92, 27.93, 27.94, 27.95, 27.96, 27.97, 27.98, 27.99, 28.00, 28.01, 28.02, 28.03, 28.04, 28.05, 28.06, 28.07, 28.08, 28.09, 28.10, 28.11, 28.12, 28.13, 28.14, 28.15, 28.16, 28.17, 28.18, 28.19, 28.20, 28.21, 28.22, 28.23, 28.24, 28.25, 28.26, 28.27, 28.28, 28.29, 28.30, 28.31, 28.32, 28.33, 28.34, 28.35, 28.36, 28.37, 28.38, 28.39, 28.40, 28.41, 28.42, 28.43, 28.44, 28.45, 28.46, 28.47, 28.48, 28.49, 28.50, 28.51, 28.52, 28.53, 28.54, 28.55, 28.56, 28.57, 28.58, 28.59, 28.60, 28.61, 28.62, 28.63, 28.64, 28.65, 28.66, 28.67, 28.68, 28.69, 28.70, 28.71, 28.72, 28.73, 28.74, 28.75, 28.76, 28.77, 28.78, 28.79, 28.80, 28.81, 28.82, 28.83, 28.84, 28.85, 28.86, 28.87, 28.88, 28.89, 28.90, 28.91, 28.92, 28.93, 28.94, 28.95, 28.96, 28.97, 28.98, 28.99, 29.00, 29.01, 29.02, 29.03, 29.04, 29.05, 29.06, 29.07, 29.08, 29.09, 29.10, 29.11, 29.12, 29.13, 29.14, 29.15, 29.16, 29.17, 29.18, 29.19, 29.20, 29.21, 29.22, 29.23, 29.24, 29.25, 29.26, 29.27, 29.28, 29.29, 29.30, 29.31, 29.32, 29.33, 29.34, 29.35, 29.36, 29.37, 29.38, 29.39, 29.40, 29.41, 29.42, 29.43, 29.44, 29.45, 29.46, 29.47, 29.48, 29.49, 29.50, 29.51, 29.52, 29.53, 29.54, 29.55, 29.56, 29.57, 29.58, 29.59, 29.60, 29.61, 29.62, 29.63, 29.64, 29.65, 29.66, 29.67, 29.68, 29.69, 29.70, 29.71, 29.72, 29.73, 29.74, 29.75, 29.76, 29.77, 29.78, 29.79, 29.80, 29.81, 29.82, 29.83, 29.84, 29.85, 29.86, 29.87, 29.88, 29.89, 29.90, 29.91, 29.92, 29.93, 29.94, 29.95, 29.96, 29.97, 29.98, 29.99, 30.00, 30.01, 30.02, 30.03, 30.04, 30.05, 30.06, 30.07, 30.08, 30.09, 30.10, 30.11, 30.12, 30.13, 30.14, 30.15, 30.16, 30.17, 30.18, 30.19, 30.20, 30.21, 30.22, 30.23, 30.24, 30.25, 30.26, 30.27, 30.28, 30.29, 30.30, 30.31, 30.32, 30.33, 30.34, 30.35, 30.36, 30.37, 30.38, 30.39, 30.40, 30.41, 30.42, 30.43, 30.44, 30.45, 30.46, 30.47, 30.48, 30.49, 30.50, 30.51, 30.52, 30.53, 30.54, 30.55, 30.56, 30.57, 30.58, 30.59, 30.60, 30.61, 30.62, 30.63, 30.64, 30.65, 30.66, 30.67, 30.68, 30.69, 30.70, 30.71, 30.72, 30.73, 30.74, 30.75, 30.76, 30.77, 30.78, 30.79, 30.80, 30.81, 30.82, 30.83, 30.84, 30.85, 30.86, 30.87, 30.88, 30.89, 30.90, 30.91, 30.92, 30.93, 30.94, 30.95, 30.96, 30.97, 30.98, 30.99, 31.00, 31.01, 31.02, 3.03, 31.04, 31.05, 31.06, 3.07, 31.08, 31.09, 31.10, 31.11, 31.12, 31.13, 31.14, 31.15, 31.16, 31.17, 31.18, 31.19, 31.20, 31.21, 31.22, 31.23, 31.24, 31.25, 31.26, 31.27, 31.28, 31.29, 31.30, 31.31, 31.32, 31.33, 31.34, 31.35, 31.36, 31.37, 31.38, 31.39, 31.40, 31.41, 31.42, 31.43, 31.44, 31.45, 31.46, 31.47, 31.48, 31.49, 31.50, 31.51, 31.52, 31.53, 31.54, 31.55, 31.56, 31.57, 31.58, 31.59, 31.60, 31.61, 31.62, 31.63, 31.64, 31.65, 31.66, 31.67, 31.68, 31.69, 31.70, 31.71, 31.72, 31.73, 31.74, 31.75, 31.76, 31.77, 31.78, 31.79, 31.80, 31.81, 31.82, 31.83, 31.84, 31.85, 31.86, 31.87, 31.88, 31.89, 31.90, 31.91, 31.92, 31.93, 31.94, 31.95, 31.96, 31.97, 31.98, 31.99, 32.00, 32.01, 32.02, 32.03, 32.04, 32.05, 32.06, 32.07, 32.08, 32.09, 32.10, 32.11, 32.12, 32.13, 32.14, 32.15, 32.16, 32.17, 32.18, 32.19, 32.20, 32.21, 32.22, 32.23, 32.24, 32.25, 32.26, 32.27, 32.28, 32.29, 32.30, 32.31, 32.32, 32.33, 32.34, 32.35, 32.36, 32.37, 32.38, 32.39, 32.40, 32.41, 32.42, 32.43, 32.44, 32.45, 32.46, 32.47, 32.48, 32.49, 32.50, 32.51, 32.52, 32.53, 32.54, 32.55, 32.56, 32.57, 32.58, 32.59, 32.60, 32.61, 32.62, 32.63, 32.64, 32.65, 32.66, 32.67, 32.68, 32.69, 32.70, 32.71, 32.72, 32.73, 32.74, 32.75, 32.76, 32.77, 32.78, 32.79, 32.80, 32.81, 32.82, 32.83, 32.84, 32.85, 32.86, 32.87, 32.88, 32.89, 32.90, 32.91, 32.92, 32.93, 32.94, 32.95, 32.96, 32.97, 32.98, 32.99, 33.00, 33.01, 33.02, 33.03, 33.04, 33.05, 33.06, 33.07, 33.08, 33.09, 33.10, 33.11, 33.12, 33.13, 33.14, 33.15, 33.16, 33.17, 33.18, 33.19, 33.20, 33.21, 33.22, 33.23, 33.24, 33.25, 33.26, 33.27, 33.28, 33.29, 33.30, 33.31, 33.32, 33.33, 33.34, 33.35, 33.36, 33.37, 33.38, 33.39, 33.40, 33.41, 33.42, 33.43, 33.44, 33.45, 33.46, 33.47, 33.48, 33.49, 33.50, 33.51, 33.52, 33.53, 33.54, 33.55, 33.56, 33.57, 33.58, 33.59, 33.60, 33.61, 33.62, 33.63, 33.64, 33.65, 33.66, 33.67, 33.68, 33.69, 33.70, 33.71, 33.72, 33.73, 33.74, 33.75, 33.76, 33.77, 33.78, 33.79, 33.80, 33.81, 33.82, 33.83, 33.84, 33.85, 33.86, 33.87, 33.88, 33.89, 33.90, 33.91, 33.92, 33.93, 33.94, 33.95, 33.96, 33.97, 33.98, 33.99, 34.00, 34.01, 34.02, 34.03, 34.04, 34.05, 34.06, 34.07, 34.08, 34.09, 34.10, 34.11, 34.12, 34.13, 34.14, 34.15, 34.16, 34.17, 34.18, 34.19, 34.20, 34.21, 34.22, 34.23, 34.24, 34.25, 34.26, 34.27, 34.28, 34.29, 34.30, 34.31, 34.32, 34.33, 34.34, 34.35, 34.36, 34.37, 34.38, 34.39, 34.40, 34.41, 34.42, 34.43, 34.44, 34.45, 34.46, 34.47, 34.48, 34.49, 34.50, 34.51, 34.52, 34.53, 34.54, 34.55, 34.56, 34.57, 34.58, 34.59, 34.60, 34.61, 34.62, 34.63, 34.64, 34.65, 34.66, 34.67, 34.68, 34.69, 34.70, 34.71, 34.72, 34.73, 34.74, 34.75, 34.76, 34.77, 34.78, 34.79, 34.80, 34.81, 34.82, 34.83, 34.84, 34.85, 34.86, 34.87, 34.88, 34.89, 34.90, 34.91, 34.92, 34.93, 34.94, 34.95, 34.96, 34.97, 34.98, 34.99, 35.00, 35.01, 35.02, 35.03, 35.04, 35.05, 35.06, 35.07, 35.08, 35.09, 35.10, 35.11, 35.12, 35.13, 35.14, 35.15, 35.16, 35.17, 35.18, 35.19, 35.20, 35.21, 35.22, 35.23, 35.24, 35.25, 35.26, 35.27, 35.28, 35.29, 35.30, 35.31, 35.32, 35.33, 35.34, 35.35, 35.36, 35.37, 35.38, 35.39, 35.40, 35.41, 35.42, 35.43, 35.44, 35.45, 35.46, 35.47, 35.48, 35.49, 35.50, 35.51, 35.52, 35.53, 35.54, 35.55, 35.56, 35.57, 35.58, 35.59, 35.60, 35.61, 35.62, 35.63, 35.64, 35.65, 35.66, 35.67, 35.68, 35.69, 35.70, 35.71, 35.72, 35.73, 35.74, 35.75, 35.76, 35.77, 35.78, 35.79, 35.80, 35.81, 35.82, 35.83, 35.84, 35.85, 35.86, 35.87, 35.88, 35.89, 35.90, 35.91, 35.92, 35.93, 35.94, 35.95, 35.96, 35.97, 35.98, 35.99, 36.00, 36.01, 36.02, 36.03, 36.04, 36.05, 36.06, 36.07, 36.08, 36.09, 36.10, 36.11, 36.12, 36.13, 36.14, 36.15, 36.16, 36.17, 36.18, 36.19, 36.20, 36.21, 36.22, 36.23, 36.24, 36.25, 36.26, 36.27, 36.28, 36.29, 36.30, 36.31, 36.32, 36.33, 36.34, 36.35, 36.36, 36.37, 36.38, 36.39, 36.40, 36.41, 36.42, 36.43, 36.44, 36.45, 36.46, 36.47, 36.48, 36.49, 36.50, 36.51, 36.52, 36.53, 36.54, 36.55, 36.56, 36.57, 36.58, 36.59, 36.60, 36.61, 36.62, 36.63, 36.64, 36.65, 36.66, 36.67, 36.68, 36.69, 36.70, 36.71, 36.72, 36.73, 36.74, 36.75, 36.76, 36.77, 36.78, 36.79, 36.80, 36.81, 36.82, 36.83, 36.84, 36.85, 36.86, 36.87, 36.88, 36.89, 36.90, 36.91, 36.92, 36.93, 36.94, 36.95, 36.96, 36.97, 36.98, 36.99, 37.00, 37.01, 37.02, 37.03, 37.04, 37.05, 37.06, 37.07, 37.08, 37.09, 37.10, 37.11, 37.12, 37.13, 37.14, 37.15, 37.16, 37.17, 37.18, 37.19, 37.20, 37.21, 37.22, 37.23, 37.24, 37.25, 37.26, 37.27, 37.28, 37.29, 37.30, 37.31, 37.32, 37.33, 37.34, 37.35, 37.36, 37.37, 37.38, 37.39, 37.40, 37.41, 37.42, 37.43, 37.44, 37.45, 37.46, 37.47, 37.48, 37.49, 37.50, 37.51, 37.52, 37.53, 37.54, 37.55, 37.56, 37.57, 37.58, 37.59, 37.60, 37.61, 37.62, 37.63, 37.64, 37.65, 37.66, 37.67, 37.68, 37.69, 37.70, 37.71, 37.72, 37.73, 37.74, 37.75, 37.76, 37.77, 37.78, 37.79, 37.80, 37.81, 37.82, 37.83, 37.84, 37.85, 37.86, 37.87, 37.88, 37.89, 37.90, 37.91, 37.92, 37.93, 37.94, 37.95, 37.96, 37.97, 37.98, 37.99, 38.00, 38.01, 38.02, 38.03, 38.04, 38.05, 38.06, 38.07, 38.08, 38.09, 38.10, 38.11, 38.12, 38.13, 38.14, 38.15, 38.16, 38.17, 38.18, 38.19, 38.20, 38.21, 38.22, 38.23, 38.24, 38.25, 38.26, 38.27, 38.28, 38.29, 38.30, 38.31, 38.32, 38.33, 38.34, 38.35, 38.36, 38.37, 38.38, 38.39, 38.40, 38.41, 38.42, 38.43, 38.44, 38.45, 38.46, 38.47, 38.48, 38.49, 38.50, 38.51, 38.52, 38.53, 38.54, 38.55, 38.56, 38.57, 38.58, 38.59, 38.60, 38.61, 38.62, 38.63, 38.64, 38.65, 38.66, 38.67, 38.68, 38.69, 38.70, 38.71, 38.72, 38.73, 38.74, 38.75, 38.76, 38.77, 38.78, 38.79, 38.80, 38.81, 38.82, 38.83, 38.84, 38.85, 38.86, 38.87, 38.88, 38.89, 38.90, 38.91, 38.92, 38.93, 38.94, 38.95, 38.96, 38.97, 38.98, 38.99, 39.00, 39.01, 39.02, 39.03, 39.04, 39.05, 39.06, 39.07, 39.08, 39.09, 39.10, 39.11, 39.12, 39.13, 39.14, 39.15, 39.16, 39.17, 39.18, 39.19, 39.20, 39.21, 39.22, 39.23, 39.24, 39.25, 39.26, 39.27, 39.28, 39.29, 39.30, 39.31, 39.32, 39.33, 39.34, 39.35, 39.36, 39.37, 39.38, 39.39, 39.40, 39.41, 39.42, 39.43, 39.44, 39.45, 39.46, 39.47, 39.48, 39.49, 39.50, 39.51, 39.52, 39.53, 39.54, 39.55, 39.56, 39.57, 39.58, 39.59, 39.60, 39.61, 39.62, 39.63, 39.64, 39.65, 39.66, 39.67, 39.68, 39.69, 39.70, 39.71, 39.72, 39.73, 39.74, 39.75, 39.76, 39.77, 39.78, 39.79, 39.80, 39.81, 39.82, 39.83, 39.84, 39.85, 39.86, 39.87, 39.88, 39.89, 39.90, 39.91, 39.92, 39.93, 39.94, 39.95, 39.96, 39.97, 39.98, 39.99, 40.00, 40.01, 40.02, 40.03, 40.04, 40.05, 40.06, 40.07, 40.08, 40.09, 40.10, 40.11, 40.12, 40.13, 40.14, 40.15, 40.16, 40.17, 40.18, 40.19, 40.20, 40.21, 40.22, 40.23, 40.24, 40.25, 40.26, 40.27, 40.28, 40.29, 40.30, 40.31, 40.32, 40.33, 40.34, 40.35, 40.36, 40.37, 40.38, 40.39, 40.40, 40.41, 40.42, 40.43, 40.44, 40.45, 40.46, 40.47, 40.48, 40.49, 40.50, 40.51, 40.52, 40.53, 40.54, 40.55, 40.56, 40.57, 40.58, 40.59, 40.60, 40.61, 40.62, 40.63, 40.64, 40.65, 40.66, 40.67, 40.68, 40.69, 40.70, 40.71, 40.72, 40.73, 40.74, 40.75, 40.76, 40.77, 40.78, 40.79, 40.80, 40.81, 40.82, 40.83, 40.84, 40.85, 40.86, 40.87, 40.88, 40.89, 40.90, 40.91, 40.92, 40.93, 40.94, 40.95, 40.96, 40.97, 40.98, 40.99, 41.00, 41.01, 41.02, 4.03, 41.04, 41.05, 41.06, 4.07, 41.08, 41.09, 41.10, 41.11, 41.12, 41.13, 41.14, 41.15, 41.16, 41.17, 41.18, 41.19, 41.20, 41.21, 41.22, 41.23, 41.24, 41.25, 41.26, 41.27, 41.28, 41.29, 41.30, 41.31, 41.32, 41.33, 41.34, 41.35, 41.36, 41.37, 41.38, 41.39, 41.40, 41.41, 41.42, 41.43, 41.44, 41.45, 41.46, 41.47, 41.48, 41.49, 41.50, 41.51, 41.52, 41.53, 41.54, 41.55, 41.56, 41.57, 41.58, 41.59, 41.60, 41.61, 41.62, 41.63, 41.64, 41.65, 41.66, 41.67, 41.68, 41.69, 41.70, 41.71, 41.72, 41.73, 41.74, 41.75, 41.76, 41.77, 41.78, 41.79, 41.80, 41.81, 41.82, 41.83, 41.84, 41.85, 41.86, 41.87, 41.88, 41.89, 41.90, 41.91, 41.92, 41.93, 41.94, 41.95, 41.96, 41.97, 41.98, 41.99, 42.00, 42.01, 42.02, 42.03, 42.04, 42.05, 42.06, 42.07, 42.08, 42.09, 42.10, 42.11, 42.12, 42.13, 42.14, 42.15, 42.16, 42.17, 42.18, 42.19, 42.20, 42.21, 42.22, 42.23, 42.24, 42.25, 42.26, 42.27, 42.28, 42.29, 42.30, 42.31, 42.32, 42.33, 42.34, 42.35, 42.36, 42.37, 42.38, 42.39, 42.40, 42.41, 42.42, 42.43, 42.44, 42.45, 42.46, 42.47, 42.48, 42.49, 42.50, 42.51, 42.52, 42.53, 42.54, 42.55, 42.56, 42.57, 42.58, 42.59, 42.60, 42.61, 42.62, 42.63, 42.64, 42.65, 42.66, 42.67, 42.68, 42.69, 42.70, 42.71, 42.72, 42.73, 42.74, 42.75, 42.76, 42.77, 42.78, 42.79, 42.80, 42.81, 42.82, 42.83, 42.84, 42.85, 42.86, 42.87, 42.88, 42.89, 42.90, 42.91, 42.92, 42.93, 42.94, 42.95, 42.96, 42.97, 42.98, 42.99, 43.00, 43.01, 43.02, 43.03, 43.04, 43.05, 43.06, 43.07, 43.08, 43.09, 43.10, 43.11, 43.12, 43.13, 43.14, 43.15, 43.16, 43.17, 43.18, 43.19, 43.20, 43.21, 43.22, 43.23, 43.24, 43.25, 43.26, 43.27, 43.28, 43.29, 43.30, 43.31, 43.32, 43.33, 43.34, 43.35, 43.36, 43.37, 43.38, 43.39, 43.40, 43.41, 43.42, 43.43, 43.44, 43.45, 43.46, 43.47, 43.48, 43.49, 43.50, 43.51, 43.52, 43.53, 43.54, 43.55, 43.56, 43.57, 43.58, 43.59, 43.60, 43.61, 43.62, 43.63, 43.64, 43.65, 43.66, 43.67, 43.68, 43.69, 43.70, 43.71, 43.72, 43.73, 43.74, 43.75, 43.76, 43.77, 43.78, 43.79, 43.80, 43.81, 43.82, 43.83, 43.84, 43.85, 43.86, 43.87, 43.88, 43.89, 43.90, 43.91, 43.92, 43.93, 43.94, 43.95, 43.96, 43.97, 43.98, 43.99, 44.00, 44.01, 44.02, 44.03, 44.04, 44.05, 44.06, 44.07, 44.08, 44.09, 44.10, 44.11, 44.12, 44.13, 44.14, 44.15, 44.16, 44.17, 44.18, 44.19, 44.20, 44.21, 44.22, 44.23, 44.24, 44.25, 44.26, 44.27, 44.28, 44.29, 44.30, 44.31, 44.32, 44.33, 44.34, 44.35, 44.36, 44.37, 44.38, 44.39, 44.40, 44.41, 44.42, 44.43, 44.44, 44.45, 44.46, 44.47, 44.48, 44.49, 44.50, 44.51, 44.52, 44.53, 44.54, 44.55, 44.56, 44.57, 44.58, 44.59, 44.60, 44.61, 44.62, 44.63, 44.64, 44.65, 44.66, 44.67, 44.68, 44.69, 44.70, 44.71, 44.72, 44.73, 44.74, 44.75, 44.76, 44.77, 44.78, 44.79, 44.80, 44.81, 44.82, 44.83, 44.84, 44.85, 44.86, 44.87, 44.88, 44.89, 44.90, 44.91, 44.92, 44.93, 44.94, 44.95, 44.96, 44.97, 44.98, 44.99, 45.00, 45.01, 45.02, 45.03, 45.04, 45.05, 45.06, 45.07, 45.08, 45.09, 45.10, 45.11, 45.12, 45.13, 45.14, 45.15, 45.16, 45.17, 45.18, 45.19, 45.20, 45.21, 45.22, 45.23, 45.24, 45.25, 45.26, 45.27, 45.28, 45.29, 45.30, 45.31, 45.32, 45.33, 45.34, 45.35, 45.36, 45.37, 45.38, 45.39, 45.40, 45.41, 45.42, 45.43, 45.44, 45.45, 45.46, 45.47, 45.48, 45.49, 45.50, 45.51, 45.52, 45.53, 45.54, 45.55, 45.56, 45.57, 45.58, 45.59, 45.60, 45.61, 45.62, 45.63, 45.64, 45.65, 45.66, 45.67, 45.68, 45.69, 45.70, 45.71, 45.72, 45.73, 45.74, 45.75, 45.76, 45.77, 45.78, 45.79, 45.80, 45.81, 45.82, 45.83, 45.84, 45.85, 45.86, 45.87, 45.88, 45.89, 45.90, 45.91, 45.92, 45.93, 45.94, 45.95, 45.96, 45.97, 45.98, 45.99, 46.00, 46.01, 46.02, 46.03, 46.04, 46.05, 46.06, 46.07, 46.08, 46.09, 46.10, 46.11, 46.12, 46.13, 46.14, 46.15, 46.16, 46.17, 46.18, 46.19, 46.20, 46.21, 46.22, 46.23, 46.24, 46.25, 46.26, 46.27, 46.28, 46.29, 46.30, 46.31, 46.32, 46.33, 46.34, 46.35, 46.36, 46.37, 46.38, 46.39, 46.40, 46.41, 46.42, 46.43, 46.44, 46.45, 46.46, 46.47, 46.48, 46.49, 46.50, 46.51, 46.52, 46.53, 46.54, 46.55, 46.56, 46.57, 46.58, 46.59, 46.60, 46.61, 46.62, 46.63, 46.64, 46.65, 46.66, 46.67, 46.68, 46.69, 46.70, 46.71, 46.72, 46.73, 46.74, 46.75, 46.76, 46.77, 46.78, 46.79, 46.80, 46.81, 46.82, 46.83, 46.84, 46.85, 46.86, 46.87, 46.88, 46.89, 46.90, 46.91, 46.92, 46.93, 46.94, 46.95, 46.96, 46.97, 46.98, 46.99, 47.00, 47.01, 47.02, 47.03, 47.04, 47.05, 47.06, 47.07, 47.08, 47.09, 47.10, 47.11, 47.12, 47.13, 47.14, 47.15, 47.16, 47.17, 47.18, 47.19, 47.20, 47.21, 47.22, 47.23, 47.24, 47.25, 47.26, 47.27, 47.28, 47.29, 47.30, 47.31, 47.32, 47.33, 47.34, 47.35, 47.36, 47.37, 47.38, 47.39, 47.40, 47.41, 47.42, 47.43, 47.44, 47.45, 47.46, 47.47, 47.48, 47.49, 47.50, 47.51, 47.52, 47.53, 47.54, 47.55, 47.56, 47.57, 47.58, 47.59, 47.60, 47.61, 47.62, 47.63, 47.64, 47.65, 47.66, 47.67, 47.68, 47.69, 47.70, 47.71, 47.72, 47.73, 47.74, 47.75, 47.76, 47.77, 47.78, 47.79, 47.80, 47.81, 47.82, 47.83, 47.84, 47.85, 47.86, 47.87, 47.88, 47.89, 47.90, 47.91, 47.92, 47.93, 47.94, 47.95, 47.96, 47.97, 47.98, 47.99, 48.00, 48.01, 48.02, 48.03, 48.04, 48.05, 48.06, 48.07, 48.08, 48.09, 48.10, 48.11, 48.12, 48.13, 48.14, 48.15, 48.16, 48.17, 48.18, 48.19, 48.20, 48.21, 48.22, 48.23, 48.24, 48.25, 48.26, 48.27, 48.28, 48.29, 48.30, 48.31, 48.32, 48.33, 48.34, 48.35, 48.36, 48.37, 48.38, 48.39, 48.40, 48.41, 48.42, 48.43, 48.44, 48.45, 48.46, 48.47, 48.48, 48.49, 48.50, 48.51, 48.52, 48.53, 48.54, 48.55, 48.56, 48.57, 48.58, 48.59, 48.60, 48.61, 48.62, 48.63, 48.64, 48.65, 48.66, 48.67, 48.68, 48.69, 48.70, 48.71, 48.72, 48.73, 48.74, 48.75, 48.76, 48.77, 48.78, 48.79, 48.80, 48.81, 48.82, 48.83, 48.84, 48.85, 48.86, 48.87, 48.88, 48.89, 48.90, 48.91, 48.92, 48.93, 48.94, 48.95, 48.96, 48.97, 48.98, 48.99, 49.00, 49.01, 49.02, 49.03, 49.04, 49.05, 49.06, 49.07, 49.08, 49.09, 49.10, 49.11, 49.12, 49.13, 49.14, 49.15, 49.16, 49.17, 49.18, 49.19, 49.20, 49.21, 49.22, 49.23, 49.24, 49.25, 49.26, 49.27, 49.28, 49.29, 49.30, 49.31, 49.32, 49.33, 49.34, 49.35, 49.36, 49.37, 49.38, 49.39, 49.40, 49.41, 49.42, 49.43, 49.44, 49.45, 49.46, 49.47, 49.48, 49.49, 49.50, 49.51, 49.52, 49.53, 49.54, 49.55, 49.56, 49.57, 49.58, 49.59, 49.60, 49.61, 49.62, 49.63, 49.64, 49.65, 49.66, 49.67, 49.68, 49.69, 49.70, 49.71, 49.72, 49.73, 49.74, 49.75, 49.76, 49.77, 49.78, 49.79, 49.80, 49.81, 49.82, 49.83, 49.84, 49.85, 49.86, 49.87, 49.88, 49.89, 49.90, 49.91, 49.92, 49.93, 49.94, 49.95, 49.96, 49.97, 49.98, 49.99, or 50.00 parts per million by weight. This embodiment of the disclosure includes, without limitation, part per million weight ranges from a number to another number found in the array of numbers. For example, from the array of numbers above, the amount of the first and/or second generation anticoagulant may be from about 0.93 to about 5.07 parts per million by weight, because the numbers are included in the array.

In another embodiment of the present disclosure, the second rodenticidal active ingredient may be a botanical rodenticide such as scilliroside or strychnine, a carbanilate rodenticide, such as mieshuan; a coumarin rodenticide such as brodifacoum, bromadiolone, coumachlor, coumafuryl, coumatetralyl, dicoumarol, difenacoum, difethialone, flocoumafen, warfarin; an indandione rodenticide, such as chlorophacinone, diphacinone, naphthylindane-1,3-diones, pindone, or valone; an inorganic rodenticide, such as arsenous oxide, phosphorus, potassium arsenite or sodium arsenite, thallium sulfate, or zinc phosphide; an organochlorine rodenticide, such as gamma-HCH, HCH, or lindane; an organofluorine rodenticide, such as fluoroacetamide, fluoroacetic acid, gliftor, or sodium fluoroacetate; an organophosphorus rodenticide, such asphosacetim; a pyrimidinamine rodenticide, such as crimidine; a •thiourea rodenticide, such as 1-naphthalenylthiourea, (1EZ)-3-(3,4-dichlorophenyl)triaz-1-ene-1-carbothioamide, or thiosemicarbazide; a •urea rodenticide, such as pyrinuron, or bromethalin, (R)-1,2-O-(2,2,2-trichloroethylidene)-α-D-glucofuranose, α-chlorohydrin, cholecalciferol, copper acetoarsenite, curcumenol, ergocalciferol, flupropadine, hydrogen cyanide, norbormide, silatrane, or tetramine.

In another embodiment of the present disclosure, the composition may comprise an antibiotic or another bacteriostatic agent, for example sulfaquinoxaline. In another embodiment, vitamin D may be used in the present composition.

The second rodenticidal active ingredient may also be used in a rodenticidally effective amount, if uncombined with the rodenticidally effective amount of the carbon dioxide release agent. In another embodiment the carbon dioxide release agent and the second rodenticidal active ingredient may be provided in a synergistically effective amount. By the term synergistically effective amount may be meant a synergistically effective combination according to the Colby formula. See S. R. Colby, “Calculating Synergistic and Antagonistic Responses of Herbicide Combinations”, Weeds 1967, 15, 20-22.

According to the Colby Formula, an expected rodenticidal activity for a given combination of 2 or 3 compounds can be calculated as follows: X denotes the lethality when using compound A at an application rate of m; Y denotes the lethality when using compound B at an application rate of n; and Z denotes the lethality when using compound C at an application rate of r; E₁ denotes the calculated lethality when using the compounds A and B at application rates of m and n; and E₂ denotes the calculated lethality when using compounds A and B and C at application rates of m and n and r. The calculated lethality E₁=X+Y−(X Y/100); and the calculated lethality E₂=X+Y+Z−((X Y−X Z−Y Z)/100)+X Y Z/10000.

Rodenticidal activity (e.g., X, Y, and Z) may be measured in percent lethality. 0% denotes an lethality which corresponds to that of the control, while an lethality of 100% means that no death may be observed. If the actual rodenticidal activity may be greater than that calculated, then the activity of the combination may be superadditive: in other words, a synergistic effect may be obtained. Said differently, a synergistic rodenticidal effect may be shown if the observed lethality may be greater than the calculated lethality E₁ or E₂.

In another embodiment of the present disclosure, there may be provided a method of controlling rodents at a locus comprising applying the composition to the locus. The locus may be a bait box, a domestic house, an apartment, a condominium, a farm, a field, a woodland, a farmland, or any other locus known to the person of ordinary skill in the art in need of rodent control. In another embodiment of the present disclosure, the composition may be applied advantageously to or in a locus to avoid non-target species from being dosed by the composition; or where such non-target pests are particularly sensitive to traditional rodenticide poison.

In another embodiment of the present disclosure the composition may be used around humans with little, or lowered, or low, risk of toxicity or adventitious ingestion of a clinically effective dose of another rodenticide. In another embodiment, the composition may be benign to humans, or may be substantially benign to humans.

The rodents to be controlled may be wild, foraging, domestic, commensal, or any other type of rodent known to the person of ordinary skill in the art. Rodents include mice, (Mus), for example field mice, or house mice (Peromyscus spp., e.g., Peromyscus leucopus) and/or the deer mouse (Peromyscus maniculatus). Rodents include rats, e.g., the genus Rattus, a member of the giant subfamily Murinae. Several other murine genera are sometimes considered part of Rattus: Lenothrix, Anonymomys, Sundamys, Kadarsanomys, Diplothrix, Margaretamys, Lenomys, Komodomys, Palawanomys, Bunomys, Nesoromys, Stenomys, Taeromys, Paruromys, Abditomys, Tryphomys, Limnomys, Tarsomys, Bullimus, Apomys, Millardia, Srilankamys, Niviventer, Maxomys, Leopoldamys, Berylmys, Mastomys, Myomys, Praomys, Hylomyscus, Heimyscus, Stochomys, Dephomys, and Aethomys. Rattus rattus and Rattus norvegicus may be controlled by the present disclosure.

In another embodiment of the present disclosure there may be provided a method of preventing overdosing of an anticoagulant in a rodent feeding on a rodenticidally active composition comprising the anticoagulant, which method comprises placing a composition comprising the carbon dioxide release agent and the carrier in an amount to prevent or substantially attenuate overfeeding by the rodent. By overfeeding may be meant the rodent consuming more than a lethal dose of the rodenticidally active composition comprising the anticoagulant. Typically, with a second-generation anticoagulant, a rodent will consume more anticoagulant that may be necessary to kill the rodent. If the rodent consumes more than necessary, then its body may become a poison for a scavenger animal, or an animal of prey. The method of the present disclosure may be designed to attenuate or prevent such overfeeding by the rodent. By the term attenuate may be generally meant decreasing consumption of the composition of the disclosure as a percentage of the amount normally consumed by a population of rodents when the composition does not contain the carbon dioxide release agent.

In another embodiment of the disclosure, the attenuation may be chosen from a list of numbers in the following number array: 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 percent attenuation. This embodiment of the disclosure includes, without limitation, percent attenuation from any one integer to another integer found in the array of numbers. For example, from the numbers above, the percent attenuation may be from about 13% to about 79%, because the numbers are included in the array.

In another embodiment of the present disclosure there may be provided a method of preventing exposure of an nontarget pest or human to a clinically effective dose of a first or second generation anticoagulant comprising placing the composition of the present disclosure at a locus where rodents need to be controlled and wherein the nontarget pest or human may be in the same locus, or the nontarget pest and/or the human live commensally with the rodent

In another embodiment of the present disclosure there may be provided a method of bacterial or viral disease control, which disease may be directly transmitted by a rodent and/or indirectly transmitted by a disease vector, or parasite of the rodent, and which method comprises applying to a locus where the rodent and/or the disease vector, or the parasite of the rodent, may be found, or may be expected to be found, an effective amount of a composition comprising a rodenticidally effective amount of a carbon dioxide release agent and a rodenticidally acceptable carrier. Such diseases include direct-contact diseases including, Hantavirus Pulmonary Syndrome, Hemorrhagic Fever with Renal Syndrome, Lassa Fever, Leptospirosis, Lymphocytic Chorio-meningitis, Omsk Hemorrhagic Fever, Plague, Rat-Bite Fever, Salmonellosis, South American Arenaviruses and Tularemia. Indirect contact diseases include Babesiosis, California Serogroup Viruses, Colorado Tick Fever, Cutaneous Leishmaniasis, Human Granulocytic Anaplasmosis, Lyme Disease, Murine Typhus, Hemorrhagic Fever, Powassan Encephalitis, Scrub Typhus, Rickettsialpox, Relapsing Fever, Rocky Mountain Spotted Fever, Sylvatic Typhus, and Western Equine Encephalitis. According to the Centers for Disease Control (CDC), rodents hosting such vectors or parasites include Deer mouse (Peromyscus maniculatus), Cotton rat (Sigmodon Hispidus), Rice rat (Oryzomys palustris), White-footed mouse (Peromyscus leucopus), Striped field mouse (Apodemus agrarius), brown or Norway rat (Rattus norvegicus), bank vole (Clethrionomys glareolus), yellow-necked field mouse (Apodemus flavicollis), Multi-mammate rat (Mastomys natalensis species complex), House mouse (Mus musculus), Muskrats, narrow-skulled vole, rock squirrels, prairie dogs, wood rats, fox squirrels, Cane rat (Zygodontomys brevicauda), drylands vesper mouse, (Calomys musculinus), large vesper mouse (Calomys callosus), ground squirrel, beavers, bushy-tailed woodrat, porcupine, and the like.

Examples of the disease vector or parasites of the rodents include flea, mite, louse, mosquito, and sand fly. While not limited to any particular scientific theory, such disease vectors or parasites typically transmit a disease organism to the rodent, which rodent serves as a biological harborage for the disease organism, whether viral or bacterial.

In another aspect of the present disclosure, the composition may comprise an arthropocidal active ingredient and/or an effective amount of an arthropod repellent. An arthropod includes insects and arachnids, e.g., louse, mite, tick, flea, and the like, particularly those that are rodent parasites or disease vectors. Such an amount of an arthropocidal active ingredient may repel and/or be lethal, that is, kill the arthropod. Such arthropocidal active ingredient may be one or more of the following:

2.1 Carbamates, for example alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulfan, cloethocarb, dimetilan, ethiofencarb, fenobucarb, fenothiocarb, formetanate, furathiocarb, isoprocarb, metam-sodium, methiocarb, methomyl, metolcarb, oxamyl, pirimicarb, promecarb, propoxur, thiodicarb, thiofanox, trimethacarb, XMC, xylylcarb, triazamate

2.2 Organophosphates, for example acephate, azamethiphos, azinphos (-methyl, -ethyl), bromophos-ethyl, bromfenvinfos (-methyl), butathiofos, cadusafos, carbophenothion, chlorethoxyfos, chlorfenvinphos, chlormephos, chlorpyrifos (-methyl/-ethyl), coumaphos, cyanofenphos, cyanophos, chlorfenvinphos, demeton-s-methyl, demeton-s-methylsulphon, dialifos, diazinon, dichlofenthion, dichlorvos/DDVP, dicrotophos, dimethoate, dimethylvinphos, dioxabenzofos, disulfoton, EPN, ethion, ethoprophos, etrimfos, famphur, fenamiphos, fenitrothion, fensulfothion, fenthion, flupyrazofos, fonofos, formothion, fosmethilan, fosthiazate, heptenophos, iodofenphos, iprobenfos, isazofos, isofenphos, isopropyl O-salicylate, isoxathion, malathion, mecarbam, methacrifos, methamidophos, methidathion, mevinphos, monocrotophos, need, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulfotep, sulprofos, tebupirimfos, temephos, terbufos, tetrachlorvinphos, thiometon, triazophos, triclorfon, vamidothion

2. Sodium channel modulators/voltage dependent sodium channel blockers

2.1 Pyrethroids, for example acrinathrin, allethrin (d-cis-trans, d-trans), beta-cyfluthrin, bifenthrin, bioallethrin, bioallethrin ((S)-cyclopentyl isomer), bioethanomethrin, biopermethrin, bioresmethrin, chlovaporthrin, cis-cypermethrin, cis-resmethrin, cis-permethrin, clocythrin, cycloprothrin, cyfluthrin, cyhalothrin, cypermethrin (alpha-, beta-, theta-, zeta-), cyphenothrin, deltamethrin, empenthrin (1R-isomer), esfenvalerate, etofenprox, fenfluthrin, fenpropathrin, fenpyrethrin, fenvalerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R-trans isomer), prallethrin, profluthrin, protrifenbute, pyresmethrin, resmethrin, RU 15525, silafluofen, tau-fluvalinate, tefluthrin, terallethrin, tetramethrin (IR-isomer), tralomethrin, transfluthrin, ZXI 8911, pyrethrins (pyrethrum) DDT

2.2 oxadiazines, for example, indoxacarb

3. Acetylcholine-receptor agonists/antagonists

3.1 chloronicotyinyls, for example acetamiprid, clothianidin, dinotefuran, imidacloprid, nitenpyram, nithiazine, thiacloprid, thiamethoxam

3.2 nicotine, bensultap, cartap

4. Acetylcholine-receptor-modulators

4.1 spinosyns, for example spinosad

6. GABA-regulated chloride-channel antagonists

6.1 cyclodiene organochlorines, for example camphechlor, chlordane, endosulfan, gamma-HCH, HCH, heptachlor, lindane, methoxychlor

6.2 fiproles, for example acetoprole, ethiprole, fipronil, flufiprole, pyraclofos, pyrafluprole, pyriprole, pyrolan, vaniliprole

6. Chloride-channel activators

6.1 mectins, for example avermectin, emamectin, emamectin-benzoate, ivermectin, milbemycin

7. Juvenile-hormone mimics, for example diofenolan, epofenonane, fenoxycarb, hydroprene, kinoprene, methoprene, pyriproxyfen, triprene

8. Ecdysone agonists/disruptors

8.1 diacylhydrazine, for example chromafenozide, halofenozide, methoxyfenozide, tebufenozide

9. Chitin biosynthesis inhibitors

9.1 benzoylureas, for example bistrifluoron, chlorfluazuron, diflubenzuron, fluazuron, flucycloxuron, flufenoxuron, hexaflumuron, lufenuron, novaluron, noviflumuron, penfluoron, teflubenzuron, triflumuron

9.2 buprofezin

9.3 cyromazine

12. Oxidative phosphorylation inhibitors, ATP disruptors

12.1 diafenthiuron

12.2 organotins, for example azocyclotin, cyhexatin, fenbutatin-oxide

12. Uncouping oxidative phosphorylation by short circuiting the H proton gradient

12.1 pyrroles, for example chlorfenapyr

12.2 dinitrophenols, for example binapacryl, dinobuton, dinocap, DNOC

12. Site-I electron transport inhibitors

12.1 METI's, for example fenazaquin, fenpyroximate, pyrimidifen, pyridaben, tebufenpyrad, tolfenpyrad

12.2 hydramethylnon

12.3 dicofol

13. Site-II electron transport inhibitors rotenone

14. Site-III electron transport inhibitors acequinocyl, fluacrypyrim

16. Microbial disruptors of insect mid-gut membranes Bacillus thuringiensis strains

16. Fat-synthesis inhibitors tetronic acids, for example spirodiclofen, spiromesifen tetramic acids, for example 3-(2,5-dimethylphenyl)-8-methoxy-2-oxo-1-azaspiro[4.5]dec-3-en-4-yl ethyl carbonate (alias: carbonic acid, 3-(2,5-dimethylphenyl)-8-methoxy-2-oxo-1-azaspiro[4.5]dec-3-en-4-yl ethyl ester, CAS-reg.-no.: 382618-11-8) and carbonic acid, cis-3-(2,5-dimethylphenyl)-8-methoxy-2-oxo-1-azaspiro[4.5]dec-3-ene-4-yl ethyl ester (CAS-reg.-no.: 213313-25-1)

17. Carboxamides, for example flonicamid

18. Octopaminergic agonists, for example amitraz

19. Magnesium-stimulated ATPase inhibitors, for example propargite

22. BDCAs, for example N2-[1,1-dimethyl-2-(methyl sulfonyl)ethyl]-3-iodo-N1-[2-methyl-4-[1,2,2,2-tetrafluoro-1-(trifluorome-thyl)ethyl]phenyl]-1,2-benzene dicarboxamide (CAS reg. no.: 272451-65-7)

22. Nereistoxin analogues, for example thiocyclam hydrogen oxalate, thiosultap sodium

22. Biological agents, hormones or pheromones, for example azadirachtin, bacillus spp., Beauveria spp., codlemone, metarrhizium spp., Paecilomyces spp., Thuringiensin, Verticillium spp.

23. Active ingredients with unknown or non-specific mechanisms of action

23.1 fumigants, for example aluminium phosphide, methyl bromide, sulfuryl fluoride,

23.2 selective antifeedants, for example cryolite, flonicamid, pymetrozine

23.3 mite growth inhibitors, for example clofentezine, etoxazole, hexythiazox

23.4 amidoflumet, benclothiaz, benzoximate, bifenazate, bromopropylate, buprofezin, chinomethionat, chlordimeform, chlorobenzilate, chloropicrin, clothiazoben, cycloprene, dicyclanil, fenoxacrim, fentrifanil, flubenzimine, flufenerim, flufenzin, gossyplure, hydramethylnone, japonilure, metoxadiazone, petroleum, piperonyl butoxide, potassium oleate, pyridalyl, sulfluramid, tetradifon, tetrasul, triarathene, verbutin, and (1R-cis)-[5-(phenylmethyl)-3-furanyl]-methyl-3-[(dihydro-2-oxo-3(2H)-fura-nylidend)-methyl]-2,2-dimethyl cyclopropane carboxylate (3-phenoxyphenyl)-methyl-2,2,3,3-tetramethyl cyclopropane carboxylate 1-[(2-chloro-5-thiazolyl)methyl]tetrahydro-3,5-dimethyl-N-nitro-1-,3,5-triazine-2(1H)-imine 2-(2-chloro-6-fluorphenyl)-4-[4-(1,1-dimethylethyl)phenyl]-4,5-dihydro-ox-azole 2-(acetylyoxy)-3-dodecyl-1,4-naphthalend ione 2-chloro-N-[[[4-(1-phenylethoxy)-phenyl-]amino]-carbonyl-]benzamide 2-chloro-N-[[[4-(2,2-dichloro-1,1-difluorethoxy)-phenyl]-amino]-c-arbonyl]-benzamide 3-methylphenyl-propyl carbamate 4-[4-(4-ethoxyphenyl)-4-methylpentyl]-1-fluoro-2-phenoxy-benzole 4-chloro-2-(1,1-dimethylethyl)-5-[[2-(2,6-dimethyl-4-phenoxyphenoxy)ethyl-]thio]-3(2H)-pyridazinone 4-chloro-2-(2-chloro-2-methylpropyl)-5-[(6-iodo-3-pyridinyl)methoxy]-3(2H-)-pyridazinone 4-chloro-5-[(6-chloro-3-pyridinyl)methoxy]-2-(3,4-dichlorphenyl)-3(2H)-py-ridazinone Bacillus thuringiensis strain EG-2348 benzoic acid [2-benzoyl-1-(1,1-dimethylethyl)-hydrazide butyric acid 2,2-dimethyl-3-(2,4-dichlorophenyl)-2-oxo-1-oxaspiro[4.5]dec-3-ene-4-yl-ester [3-[(6-chloro-3-pyridinyl)methyl]-2-thiazolidinylidene]-cyanamide dihydro-2-(nitromethylene)-2H-1,3-thiazine-3(4H)-carboxaldehyde ethyl-[2-[[1,6-dihydro-6-oxo-1-(phenylmethyl)-4-pyridazinyl]oxy]ethyl]-ca-rbamate N-(3,4,4-trifluor-1-oxo-3-butenyl)-glycine N-(4-chlorophenyl)-3-[4-(difluoromethoxy)phenyl]-4,5-dihydro-4-phenyl-1H-pyrazole-1-carboxamide N-methyl-N′-(1-methyl-2-propenyl)-1,2-hydrazine dicarbothioamide N-methyl-N′-2-propenyl-1,2-hydrazine dicarbothioamide O,O-diethyl-[2-(dipropylamino)-2-oxoethyl]-ethyl phosphoroamidothioate

The percent weight of any arthropocidal active ingredient in the composition will, generally, be far less than the percent weight of the carbon dioxide release agent. The arthropocidal active ingredient may be provided in the bait in percent weight amount selected from the following array of numbers: 0.0010, 0.0011, 0.0012, 0.0013, 0.0014, 0.0015, 0.0016, 0.0017, 0.0018, 0.0019, 0.0020, 0.0021, 0.0022, 0.0023, 0.0024, 0.0025, 0.0026, 0.0027, 0.0028, 0.0029, 0.0030, 0.0031, 0.0032, 0.0033, 0.0034, 0.0035, 0.0036, 0.0037, 0.0038, 0.0039, 0.0040, 0.0041, 0.0042, 0.0043, 0.0044, 0.0045, 0.0046, 0.0047, 0.0048, 0.0049, 0.0050, 0.0051, 0.0052, 0.0053, 0.0054, 0.0055, 0.0056, 0.0057, 0.0058, 0.0059, 0.0060, 0.0061, 0.0062, 0.0063, 0.0064, 0.0065, 0.0066, 0.0067, 0.0068, 0.0069, 0.0070, 0.0071, 0.0072, 0.0073, 0.0074, 0.0075, 0.0076, 0.0077, 0.0078, 0.0079, 0.0080, 0.0081, 0.0082, 0.0083, 0.0084, 0.0085, 0.0086, 0.0087, 0.0088, 0.0089, 0.0090, 0.0091, 0.0092, 0.0093, 0.0094, 0.0095, 0.0096, 0.0097, 0.0098, 0.0099, 0.010, 0.011, 0.012, 0.013, 0.014, 0.015, 0.016, 0.017, 0.018, 0.019, 0.020, 0.021, 0.022, 0.023, 0.024, 0.025, 0.026, 0.027, 0.028, 0.029, 0.030, 0.031, 0.032, 0.033, 0.034, 0.035, 0.036, 0.037, 0.038, 0.039, 0.040, 0.041, 0.042, 0.043, 0.044, 0.045, 0.046, 0.047, 0.048, 0.049, 0.050, 0.051, 0.052, 0.053, 0.054, 0.055, 0.056, 0.057, 0.058, 0.059, 0.060, 0.061, 0.062, 0.063, 0.064, 0.065, 0.066, 0.067, 0.068, 0.069, 0.070, 0.071, 0.072, 0.073, 0.074, 0.075, 0.076, 0.077, 0.078, 0.079, 0.080, 0.081, 0.082, 0.083, 0.084, 0.085, 0.086, 0.087, 0.088, 0.089, 0.090, 0.091, 0.092, 0.093, 0.094, 0.095, 0.096, 0.097, 0.098, 0.099, 0.1, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.44, 0.45, 0.46, 0.47, 0.48, 0.49, 0.50, 0.51, 0.52, 0.53, 0.54, 0.55, 0.56, 0.57, 0.58, 0.59, 0.60, 0.61, 0.62, 0.63, 0.64, 0.65, 0.66, 0.67, 0.68, 0.69, 0.70, 0.71, 0.72, 0.73, 0.74, 0.75, 0.76, 0.77, 0.78, 0.79, 0.80, 0.81, 0.82, 0.83, 0.84, 0.85, 0.86, 0.87, 0.88, 0.89, 0.90, 0.91, 0.92, 0.93, 0.94, 0.95, 0.96, 0.97, 0.98, 0.99, 1.00, 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.20, 1.21, 1.22, 1.23, 1.24, 1.25, 1.26, 1.27, 1.28, 1.29, 1.30, 1.31, 1.32, 1.33, 1.34, 1.35, 1.36, 1.37, 1.38, 1.39, 1.40, 1.41, 1.42, 1.43, 1.44, 1.45, 1.46, 1.47, 1.48, 1.49, 1.50, 1.51, 1.52, 1.53, 1.54, 1.55, 1.56, 1.57, 1.58, 1.59, 1.60, 1.61, 1.62, 1.63, 1.64, 1.65, 1.66, 1.67, 1.68, 1.69, 1.70, 1.71, 1.72, 1.73, 1.74, 1.75, 1.76, 1.77, 1.78, 1.79, 1.80, 1.81, 1.82, 1.83, 1.84, 1.85, 1.86, 1.87, 1.88, 1.89, 1.90, 1.91, 1.92, 1.93, 1.94, 1.95, 1.96, 1.97, 1.98, 1.99, or 2.00 percent. This embodiment of the disclosure includes, without limitation, percent weight ranges from a number to another number found in the array of numbers. For example, from the array of numbers above, the percent weight amount of arthropocidal active ingredient may be from about 0.47 to about 1.03 percent by weight, because the numbers are included in the array.

The following non-limiting examples illustrate the present disclosure.

### EXAMPLE 1

A composition was prepared from 75 g of chocolate, 25 g of sodium bicarbonate and 5 g of stearic acid. The ingredients were blended together, and 30 g fed to a test mouse. A second composition was prepared from 160 g peanut butter, 60 g sodium bicarbonate and 5 g stearic acid. A 30 g portion was fed to a second test mouse. After three days, the first and second test mice were dead.

### EXAMPLE 2

The following mouse test groups were fed as follows. (3 mice were in each group, 2 subjects and 1 control). Group 1: Mouse 1: 19 g of food: 50% Mouse Food, 50% Sodium Bicarbonate; Mouse 2: 20 g of food: 75% Mouse Food, 25% Sodium Bicarbonate; Mouse 3: 20 g of food: 100% Mouse Food (control). In Group 2: Mouse 1: 21 g of food: 50% Dogmeal, 50% Sodium Bicarbonate; Mouse 2: 20.9 g of food: 75% Dogmeal, 25% Sodium Bicarbonate; Mouse 3: 20 g of food: 100% Dogmeal (control). Table 2 shows observations of the mice at 1, 2, 3, 4, and 6 days after feeding began.

TABLE 2

| Group, Mouse | Day 1 | Day 2 | Day 3 | Day 4 | Day 6 |
|---|---|---|---|---|---|
| 1, 1 | N/C | N/C | L | L | D |
| 1, 2 | N/C | N/C | L | D | D |
| 1, 3 (control) | N/C | N/C | N/C | N/C | N/C |
| 2, 1 | N/C | N/C | L | D | D |
| 2, 2 | N/C | N/C | L | D | D |
| 2, 3 (control) | N/C | N/C | N/C | N/C | N/C |

N/C = No Change from start; L = Lethargic; D = Dead

What we claim is:

1. A composition comprising a rodenticidally effective amount of a carbon dioxide release agent and a rodenticidally acceptable carrier.

2. The composition according to claim 1 wherein the carbon dioxide release agent is selected from the group consisting of a carbonate salt, a bicarbonate salt, and mixtures thereof.

3. The composition according to claim 2 wherein the carbonate salt comprises a metal cation.

4. The composition according to claim 2 wherein the bicarbonate salt comprises a metal cation.

5. The composition according to claim 3 wherein the metal cation is selected from the group consisting of alkali metal (Group 1) cations and alkaline earth metal (Group 2) cations.

6. The composition according to claim 4 wherein the metal cation further comprises a transition metal cation.

7. The composition according to claim 5 wherein the metal is selected from the group consisting of lithium, sodium, potassium, cesium, rubidium, beryllium, magnesium, calcium, strontium, barium and mixtures thereof.

8. The composition according to claim 2 wherein the carbonate salt and/or the bicarbonate salt further comprise an ammonium cation.

9. The composition according to claim 8 wherein the ammonium cation further comprises from 1 to 4 alkyl groups.

10. The composition according to claim 1 wherein the carrier further comprises a rodenticidally effective bait.

11. The composition according to claim 10 wherein the bait further comprises an ingredient selected from the group consisting of a protein, a fatty acid and a carbohydrate.

12. The composition according to claim 11 wherein the bait further comprises an effective amount of a weak acid to accelerate the reaction with the carbon dioxide release agent.

13. The composition according to claim 1 wherein the composition is a flowable composition at ambient temperature.

14. The composition according to claim 1 further comprising a arthropocidal active ingredient and/or an effective amount of an arthropod repellent.

15. The composition according to claim 1 further comprising a rodenticidally effective amount of a second rodenticidal active ingredient.

16. The composition according to claim 1 further comprising a rodenticidally ineffective amount of a second rodenticidal active ingredient when uncombined with the rodenticidally effective amount of a carbon dioxide release agent.

17. The composition according to claim 15 further comprising a synergistically effective amount of the carbon dioxide release agent and the second rodenticidal active ingredient.

18. A method of controlling rodents at a locus comprising applying the composition according to claim 1 to the locus.

19. A method of controlling a disease vector comprising applying the composition according to claim 1 to a locus wherein the vector is expected to be found or is found in association with a rodent.

20. The method according to claim 18 wherein the composition is applied in a rodent bait box.
